(19) United States
(12) Patent Application Publication
(10) Pub. No.: US 2026/0111088 A1
(43) Pub. Date: Apr. 23, 2026

(54) CAPACITIVE TOUCH SENSOR INCLUDING FORCE REGIONS FOR FORCE DETECTION, AND RELATED METHODS, APPARATUSES, AND SYSTEMS

(71) Applicant: Microchip Touch Solutions Limited, Wokingham (GB)

(72) Inventor: Jake Drew, Oxford (GB)

(21) Appl. No.: 19/365,470

(22) Filed: Oct. 22, 2025

Related U.S. Application Data
(60) Provisional application No. 63/710,718, filed on Oct. 23, 2024.

(51) Int. Cl. G06F 3/044; G06F 3/0362; G06F 3/041

(52) U.S. Cl. CPC G06F 3/0445; G06F 3/0362; G06F 3/0414; G06F 3/04166; G06F 3/0447; G06F 2203/04106; G06F 2203/04107

(57) ABSTRACT

An apparatus includes a capacitive touch sensor. The capacitive touch sensor is to provide first capacitive node measurements for capacitive touch detection responsive to touch at a respective one of multiple touch points within a capacitive touch-sensitive area of the capacitive touch sensor. The first capacitive node measurements indicate a reduction in capacitance at one or more first capacitive nodes of the capacitive touch sensor. The capacitive touch sensor is to also provide second capacitive node measurements for force detection responsive to touch surface depression at a respective one of one or more force regions of the capacitive touch sensor. The second capacitive node measurements indicate an increase in capacitance at one or more second capacitive nodes of the capacitive touch sensor. In one or more examples, the one or more force regions are vertically-displaceable, sectioned portions of one or more vertically-stacked layers of the capacitive touch sensor.

### CROSS-REFERENCE TO RELATED APPLICATION

This application claims the benefit under 35 U.S.C. § 119(e) of U.S. Provisional Patent Application Ser. No. 63/710,718, filed Oct. 23, 2024, the disclosure of which is hereby incorporated herein in its entirety by this reference.

### TECHNICAL FIELD

Disclosed examples relate, generally, to capacitive touch sensing, and more specifically, to capacitive touch sensors including force regions for force detection, and related methods, apparatuses, and systems.

### BACKGROUND

A typical touch interface system may incorporate touch sensors (e.g., capacitive sensors and/or resistive sensors, without limitation) that respond to an object in close proximity to, or physical contact with, a contact sensitive surface of a touch interface system. Such responses may be captured and interpreted to infer information about the contact, including a location of an object relative to the touch interface system. Touchpads used with personal computers, including laptop computers and keyboards for tablets, often incorporate or operate in conjunction with a touch interface system.

Displays often include touchscreens that incorporate elements (typically at least a touch sensor) of a touch interface system to enable a user to interact with a graphical user interface (GUI) and/or computer applications. Examples of devices that incorporate a touch display include portable media players, televisions, smart phones, tablet computers, personal computers, and wearables such as smart watches, just to name a few. Further, control panels for automobiles, appliances (e.g., an oven, refrigerator or laundry machine) security systems, automatic teller machines (ATMs), residential environmental control systems, and industrial equipment may incorporate touch interface systems with displays and housings, including to enable buttons, sliders, wheels, and other touch elements.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a perspective view of a system comprising a touchscreen device including a touchscreen, according to one or more examples of the disclosure;

FIG. 2 is a frontal view of the touchscreen of FIG. 1;

FIG. 3 depicts a capacitive touch system that is known by the inventors of this disclosure;

FIG. 4 is a schematic block diagram of a touch controller of FIG. 3 in a conventional circuit arrangement;

FIG. 5 is a top-down view of a multi-layer arrangement of a capacitive touch sensor that is known by the inventor of this disclosure;

FIG. 6 is a cross-sectional view of the multi-layer arrangement of the capacitive touch sensor of FIG. 5;

FIG. 7 is a top-down view of a multi-layer arrangement of capacitive touch sensor including one or more force regions, according to one or more examples of the disclosure;

FIGS. 8A and 8B are respective cross-sectional views of the multi-layer arrangement of the capacitive touch sensor of FIG. 7, according to one or more examples;

FIGS. 9A and 9B are other respective cross-sectional views of the multi-layer arrangement of the capacitive touch sensor of FIG. 7, according to one or more examples;

FIG. 10 is graph of capacitive node measurements relating to capacitance or voltage (C/V) over time for both capacitive touch detection and force detection, according to one or more examples;

FIG. 11 is a schematic diagram of an apparatus including a capacitive touch system having a touch controller and a capacitive touch sensor, according to one or more examples;

FIG. 12 is a flowchart of a method of a capacitive touch sensor, according to one or more examples;

FIG. 13 is a flowchart of a method of a touch controller, according to one or more examples;

FIG. 14 is a flowchart of a method of a touch controller, according to one or more examples;

FIGS. 15A and 15B depict respective cross-sectional views of a push button device for a touchscreen, according to one or more examples;

FIGS. 16A, 16B, and 16C are respective views of a Knob-on-Display (KoD) device that is known by the inventor of this disclosure;

FIG. 17A depicts a cross-sectional view of a KoD device for a touchscreen, according to one or more examples;

FIGS. 17B and 17C depict respective cross-sectional views of the KoD device of FIG. 17A to further include a push button device, according to one or more examples;

FIG. 17D is a number of force regions arranged in an annulus of a capacitive touch sensor, for use with the KoD device of FIG. 17A and/or FIGS. 17B and 17C, according to one or more examples; and

FIG. 18 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Touchscreens are popular today as they are intuitive, versatile, and cost-effective. For example, touchscreens are the primary interface used in software-defined vehicles (SDVs). Recently, vehicle safety rules of the European New Car Assessment Program (Euro NCAP) have been updated to limit the safety rating of a vehicle to only four (4) out of five (5) stars (i.e., 4/5 stars) if all of the controls of the vehicle are controlled via a touchscreen. Even still, the current trend is to employ larger and larger touchscreens in vehicles. The rule change of the Euro NCAP could signify a return to the use of more (e.g., physical or tactile, without limitation) “buttons” in such interface systems.

In a typical arrangement of a multi-layer capacitive touch sensor, a touch controller detects a point within an array of intersecting electrodes in which a change in capacitance is sensed (e.g., a touch). A multi-layer arrangement including the array of intersecting electrodes includes a bottom layer of drive electrodes connected to respective drive lines (e.g., X lines) and a top layer of sense electrodes connected to respective sense lines (e.g., Y lines). The drive lines are coupled to respective outputs of the touch controller and the sense lines are coupled to respective inputs of the touch controller. An adhesive layer may be used to separate the top layer from the bottom layer. A protective layer of glass or Perspex may be provided over the top layer.

In view of the vehicle safety rule change, additional sensing means based on the application of force or pressure (“force sensing”) to accommodate screen “buttons” may be considered. For example, an additional layer for force sensing may be provided in the multi-layer arrangement discussed above. However, such an additional layer would consume sense lines and analog front-end resources of the touch controller. These limited resources of the touch controller for force sensing would then be unavailable for standard capacitive sensing, which would potentially decrease the screen size of the touchscreen. On the other hand, resistive touch methods may be used for force sensing, but these methods are generally unable to detect the position of multiple touches at the same time and are incompatible with capacitive touch sensors. If multi-touch sensing was desired, resistive touch methods would require an additional layer on top of the layered arrangement.

According to one or more examples of the disclosure, a multi-layer arrangement of a capacitive touch sensor is configured with a limited number of isolated “force regions” for force sensing. The force regions may be vertically-displaceable, sectioned portions of one or more vertically-stacked layers of the capacitive touch sensor. For example, force regions may be made as flexible nodes or flexible node regions in the multi-layer arrangement. In at least some contexts, the isolated force regions may be said to be integrated within the one or more vertically-stacked layers of the capacitive touch sensor. Respective ones of the force regions are vertically-displaceable (e.g., made vertically-movable, flexible, pliable, bendable, without limitation) to allow only a portion of the top layer within the region to move toward the bottom layer responsive to touch surface force or pressure. Meanwhile, the remaining surrounding top layer (e.g., the capacitive touch-sensing area) remains relatively stationary, and/or is prevented from bending or depressing, even during such force or pressure.

Respective ones of the force regions are associated with a respective set of capacitive nodes that are sensed and detected by the touch controller at least partially responsive to the force or pressure at the region. In one or more examples, current capacitive touch sensing methods may be used for force detection at the force regions. More particularly, when force or pressure is applied to a force region, the capacitance increases as the distance between the electrodes decrease (e.g., in contrast to the capacitance deceasing in response to a capacitive touch). Hence, both input types may be measured based on current methods, where respective capacitive touches decrease the capacitance and respective force presses increase the capacitance.

In one or more examples, respective ones of the force regions may include tactile bumps (e.g., raised bumps or patterns) within boundaries of the respective force regions for tactile feel and/or visual aid. In one or more examples, respective ones of the force regions may include one or more additional layers over or on the top layer within boundaries of the respective force region, or one or more additional layers over or on the protective layer (e.g., Perspex or glass layer) within boundaries of the respective force region, for tactile feel and/or visual aid.

In one or more examples, the capacitive touch sensor may include a flexible or compressible layer in between the top layer and the bottom layer to facilitate the vertical displacement or flexing of the respective force region responsive to touch surface force or pressure. In one or more examples, the flexible or compressible layer may be or include a flexible or compressible adhesive layer. In one or more examples, the capacitive touch sensor may include an air gap layer in between the top layer and the bottom layer to facilitate the vertical displacement or flexing of the respective force region responsive to touch surface force or pressure.

In one or more examples, respective ones of the force regions may include modifications in mechanical and/or compositional aspects or properties in the top layer and/or protective layer within boundaries of the respective force region to facilitate the vertical displacement or flexing of the respective force region responsive to touch surface force or pressure.

Advantageously, in one or more examples, the proposed solution leverages existing multi-layer capacitive touch sensor arrangements, without requiring any silicon changes and only partial changes (if any) to firmware of the touch controller. Force region presses may be detected based on existing touch controller solutions using sense lines for measurement. Thus, in one or more examples, no additional sense lines of the touch controller are needed to incorporate force detection into the capacitive touch sensor. In one or more examples, any potential safety issues and/or potential safety rating issues are resolved (e.g., vehicle safety rules may be satisfied).

In one or more example, a Knob-on-Display (KoD) device is adapted for use with the capacitive touch sensor having force region detection. The KoD device may be mounted to a surface of the touchscreen at a location have a set of force regions. The KoD device may be a “force-based” rotary encoder including a first pressure pad to (e.g., constantly) apply force or pressure for detection associated with a rotation setting, and a second pressure pad to apply force or pressure for detection associated with a vertical button press. In this KoD design, no conductive pads or parts are necessary.

Advantageously, traditional KoD devices prevent usage of self-capacitance measurement and therefore the mutual capacitance-only system for existing KoD devices may result in reduced performance (e.g., in relation to water exposure). The KoD device of the disclosure is capable of use with self-capacitance measurement when utilized by the touch sensor.

Also in one or more examples, a push button device is adapted for use with the capacitive touch sensor having force region detection. The push button device may be mounted to a surface of the touch screen at a location having a force region (e.g., in the center of the push button). The push button device may include a pressure pad to apply force or pressure in response to a depression of the push button device (e.g., using a flexible top surface mechanically connected to the pressure pad, a spring assembly, or other component, without limitation) for detection of a vertical button press. In this push button design, no conductive pads or parts are necessary.

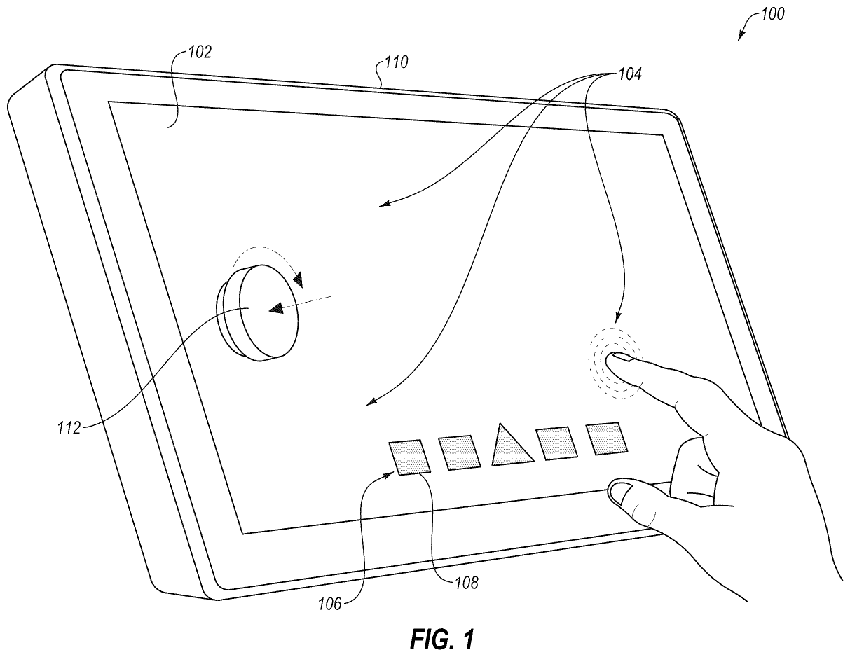

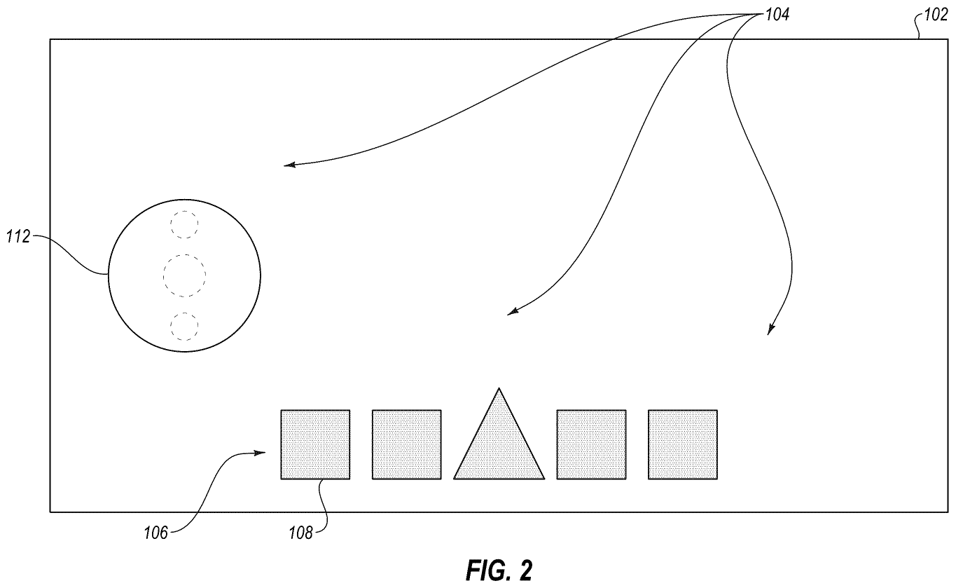

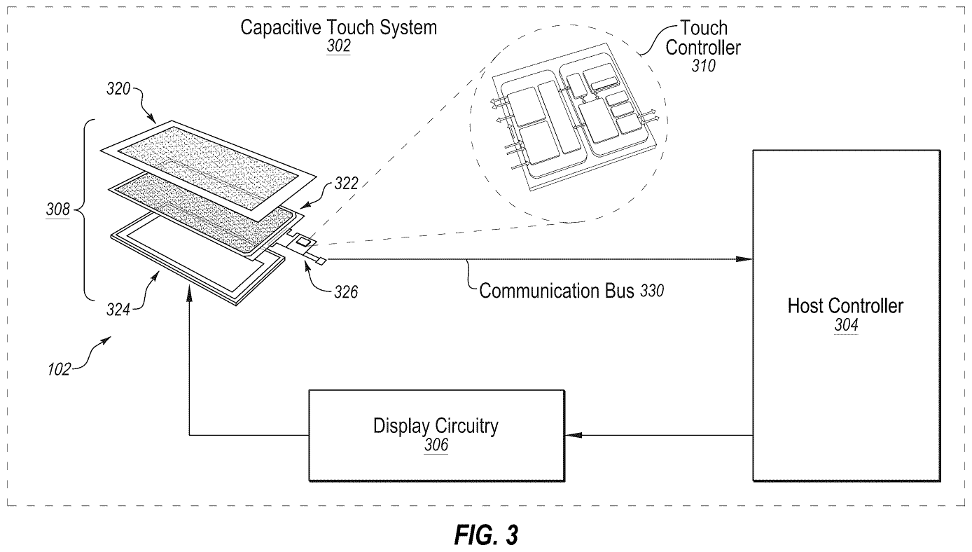

FIG. 1 is a perspective view of a system 100 comprising a touchscreen device 110 including a touchscreen 102, according to one or more examples of the disclosure. FIG. 2 is a frontal view of touchscreen 102 of FIG. 1. In one or more examples, touchscreen 102 of FIGS. 1 and 2 may utilize a capacitive touch system for capacitive touch-sensing operations (e.g., a capacitive touch system 302 of FIG. 3 to be discussed below).

In general, the capacitive touch system of touchscreen device 110 operates by detecting electrical properties of a conductive object (e.g., a human fingertip) to determine touch input within a capacitive touch-sensitive area 104. Touchscreen 102 typically includes layers coated with a transparent conductive material, such as Indium Tin Oxide (ITO). The transparent conductive material holds a small electrical charge distributed across a grid of touch-sensing regions within capacitive touch-sensitive area 104. With the help of a touch controller, each of these sensing regions contains multiple touch points that regularly measure changes in capacitance. When a user's fingertip (or other object) comes into contact with the touchscreen 102 at a touch location, it disturbs the electrostatic field at specific touch points within the sensing regions. Signals from the sensing regions are provided to the touch controller that calculates precise coordinates of the touch location. A host controller of the capacitive touch system interprets the coordinates of the touch location as a command, such as a tap, a swipe, or a pinch, and may invoke a function in response to the command.

Capacitive touchscreens are highly accurate, durable, and multi-touch capable, and are therefore widely used across many industries. Thus, touchscreen device 110 may be one of any number of different types of devices. As examples, touchscreen device 110 may be or be part of an automotive display device (e.g., in an SDV display, as an infotainment system or in-vehicle infotainment (IVI) system), a personal computer (PC), an all-in-one PC, a laptop, a tablet, a 2-in-1 hybrid device (e.g., laptop/tablet), a smartphone, a point-of-sale (PoS) terminal, a gaming device, a smart home device (e.g., to monitor, control, and/or manage lighting, temperature, security, entertainment, and household appliances), a factory control panel device (e.g., to monitor, control, and/or manage machinery or processes), or a medical device (e.g., to monitor, control, and/or manage patient monitoring systems, ultrasound machines, infusion pumps, electronic medical record (EMR) terminals, or diagnostic imaging devices), to name but a few.

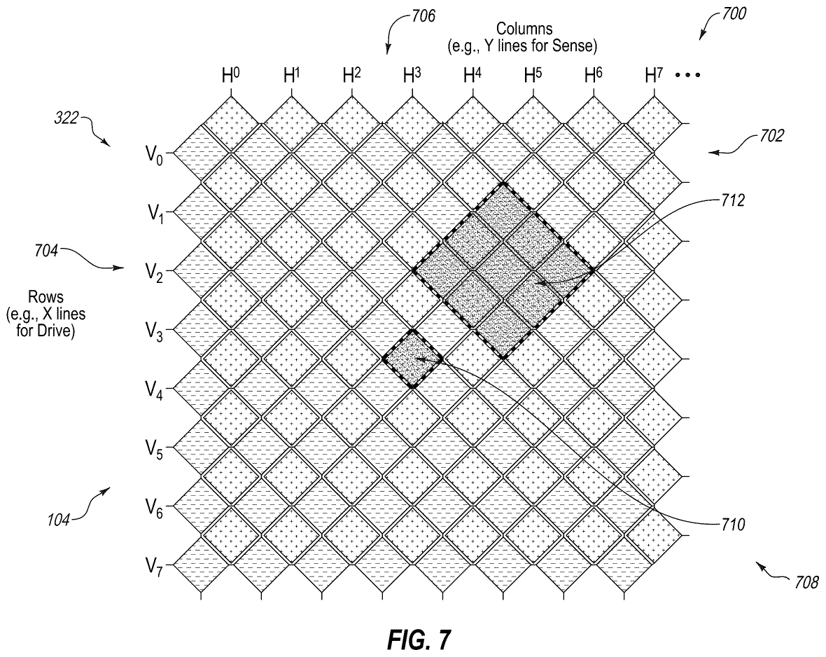

According to one or more examples of the disclosure, touchscreen 102 includes one or more touchscreen buttons 106 (such as a touchscreen button 108) respectively associated with one or more “force regions” of touchscreen 102. Respective ones of the one or more force regions generally underlie respective surfaces of one or more touchscreen buttons 106. The one or more force regions are described later below in relation to FIGS. 7, 8A, 8B, 9A, 9B, and 10-14.

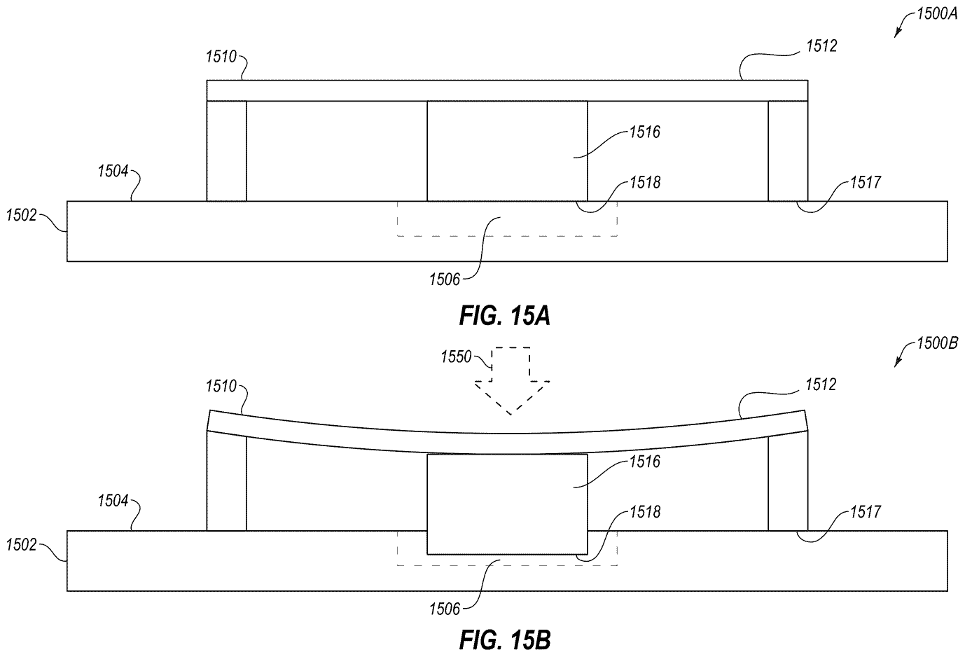

In addition, or as an alternative, touchscreen 102 may operate with a knob-on-display (KoD) device 112 or other push button device associated with one or more other “force regions” of touchscreen 102. Respective ones of the one or more other force regions generally underlie the KoD device 112 or other push button device. The one or more other force regions are described later below in relation to FIGS. 7, 8A, 8B, 9A, 9B, and 10-14, and more particularly in relation to FIGS. 15A, 15B, 16A-16C, and 17A-17D.

FIG. 3 depicts a capacitive touch system 302 that is known by the inventors of this disclosure. In one or more examples, capacitive touch system 302 is part of a touchscreen device, such as touchscreen device 110 of FIGS. 1 and 2. Capacitive touch system 302 includes touchscreen 102, a display circuitry 306, and a host controller 304. In general, touchscreen 102 comprises a multi-layered input/output (I/O) device 308 including a touch controller 310. Multi-layered I/O device 308 comprises one or more layers of a front panel 320, one or more layers of a touch sensor 322, and one or more layers of a display 324. Typically, in multi-layered I/O device 308, front panel 320 is overlaid on top of touch sensor 322, which is overlaid on top of display 324.

In one or more examples of FIG. 3, touch controller 310 is mounted on and electrically connected to a flexible cable 326, and shown in an enlarged view in a magnifying circular window for better clarity. Multi-layered I/O device 308 of touchscreen 102 is operably coupled to touch controller 310 via flexible cable 326. In particular, touch sensor 322 is operably coupled to touch controller 310 for capacitive touch detection. Touch controller 310 is further coupled to host controller 304 via a communication bus 330 via flexible cable 326. Communication bus 330 may be any suitable type of communication bus, such as an Inter-Integrated Circuit (I2C) bus, a Universal Serial Bus (USB), or a Serial Peripheral Interface (SPI) bus, without limitation. Display 324 is operably coupled to display circuitry 306, which is operably coupled to host controller 304. Display 324 may be any suitable type of display, such as a liquid crystal display (LCD), an Organic Light-Emitting Diode (OLED) display, or an Active Matrix Organic Light Emitting Diode (AMOLED) display, without limitation.

Touch controller 310 includes (e.g., dedicated) processing circuitry for processing signals of touch sensor 322 of multi-layered I/O device 308. For example, touch controller 310 is to receive raw signals associated with any capacitance changes at touch sensor 322 (i.e., from user touches), process the raw signals to determine location(s) and/or state(s) of any detected touch inputs, and translate that data into detected touch position data (e.g., detected x-y touch positions). Touch controller 310 communicates the detected touch position data (e.g., detected x-y touch positions) to host controller 304 over communication bus 330. Host controller 304 may receive and respond to the detected touch position data by performing operations or functions associated with the detected touch position data.

Host controller 304 is considered to be the main or primary controller of the device, and therefore operates to control one or more main or primary operations of the device. Main or primary operations of the device may include performing functions associated with application-specific processing of the device (e.g., functions typically associated with the application or the type of device, whether it be an automotive display device, a PC, a laptop, a tablet, a 2-in-1 hybrid device, a smartphone, a PoS terminal, a gaming device, a smart home device, a factory control panel device, a medical device, and so on). Host controller 304 receives detected touch position data via touch sensor 322, and in response, communicates signals to display circuitry 306 to display information in display 324 and performs the application-specific functions associated with the detected touch position.

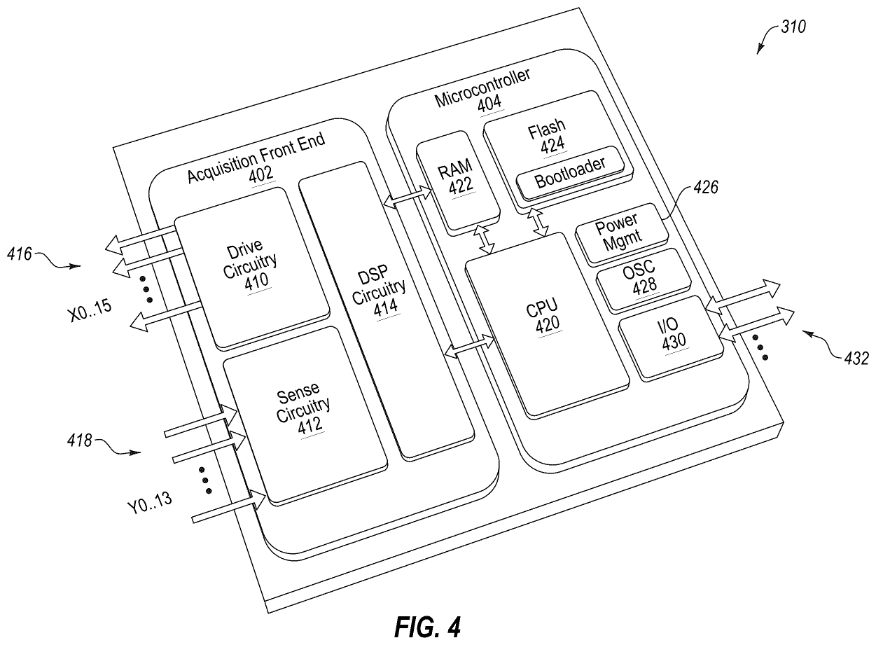

FIG. 4 is a schematic block diagram of touch controller 310 of FIG. 3 in a conventional circuit arrangement. In one or more examples, touch controller 310 of FIG. 4 includes an acquisition front end 402 and a microcontroller 404. Acquisition front end 402 includes a drive circuitry 410, a sense circuitry 412, and a digital signal processing (DSP) circuitry 414 (e.g., a DSP processing and control circuitry). Microcontroller 404 includes a central processing unit (CPU) 420, an oscillator 428, an I/O interface circuitry 430 for one or more communication buses 432, and a power management module 426. One or more clock signals may be generated from oscillator 428 and used for timing of circuitry (e.g., CPU 420, DSP circuitry 414, and so on). Microcontroller 404 also includes memory, including RAM 422 and flash memory 424 (e.g., including a bootloader process). In one or more examples, an application may be stored in flash memory 424 to control operation of CPU 420 and/or DSP circuitry 414.

In one or more examples, all or most of the components of touch controller 310 are provided in IC, such as a touch controller IC, for use in a computing device or terminal (e.g., touchscreen device 110 of FIG. 1). In one or more examples, touch controller 310 is configured with a circuit design based on a maXTouch® touch controller. maXTouch® is a registered trademark of Microchip Technology Incorporated, of Chandler, Arizona, USA.

In one or more examples, touch controller 310 includes acquisition front end 402 for processing signals of a capacitor touch sensor. Here, DSP circuitry 414 is operably coupled to drive circuitry 410, and drive circuitry 410 is coupled to a number of drive lines 416. In one or more examples, drive circuitry 410 is referred to as transmit (Tx) circuitry and the number of drive lines 416 is referred to as a number of transmit lines. In one or more examples of FIG. 4, the number of drive lines 416 includes sixteen (16) drive lines, which are designated in the figure as X0 through X15. DSP circuitry 414 is also operably coupled to sense circuitry 412, and sense circuitry 412 is coupled to a number of sense lines 418. In one or more examples, sense circuitry 412 is referred to as receive (Rx) circuitry and the number of sense lines 418 is referred to as a number of receive lines. In one or more examples of FIG. 4, the number of sense lines 418 includes fourteen (14) sense lines, which are designated in the figure as Y0 through Y13. In one or more examples, the number of drive lines 416 are provided as output pins of the touch controller IC, and the number of sense lines 418 are provided as input pins of the touch controller IC. In one or more examples, I/O interface circuitry 430 may be coupled to output pins (e.g., provided with one or more connectors).

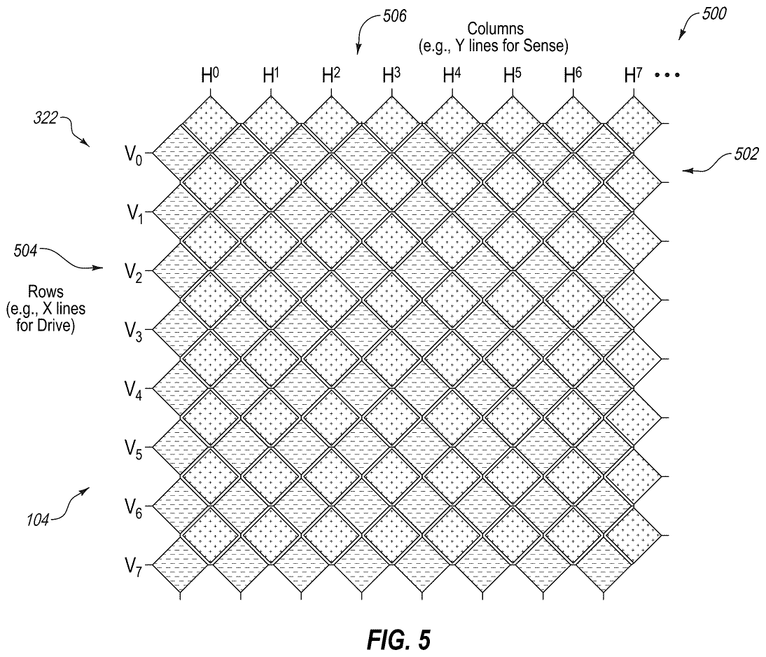

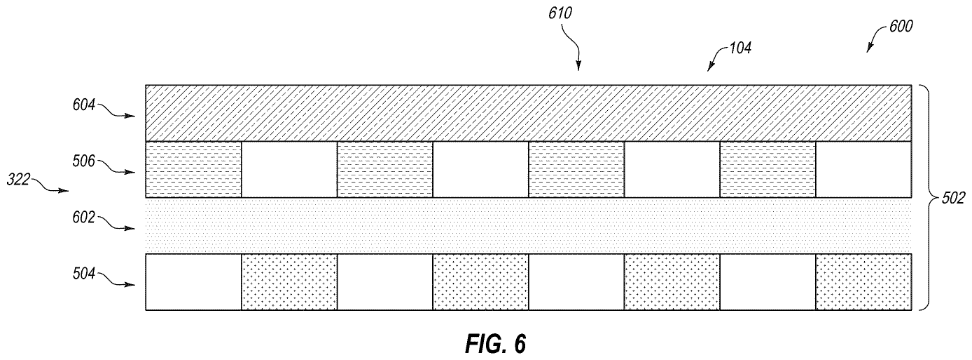

FIG. 5 is a top-down view 500 of a multi-layer arrangement 502 of capacitive touch sensor 322 that is known by the inventor of this disclosure. FIG. 6 is a cross-sectional view 600 of multi-layer arrangement 502 of capacitive touch sensor 322 of FIG. 5.

Capacitive touch sensor 322 of FIGS. 5 and 6 is adapted for mutual capacitance touch detection. With reference to FIG. 5, multi-layer arrangement 502 of capacitive touch sensor 322 includes a drive electrode layer 504 including drive electrodes (e.g., indicated by horizontal hatching, or single-line or linear hatching, in FIG. 5) and a sense electrode layer 506 including sense electrodes (e.g., indicated by grid hatching, or cross or plus hatching, in FIG. 5). In FIG. 6, it is shown that sense electrode layer 506 is stacked over drive electrode layer 504, separated by an adhesive layer 602, and covered with a protective layer 604 (e.g., Perspex or glass). Adhesive layer 602 is typically relatively firm or inflexible, as any physical movement of sense electrode layer 506 relative to drive electrode layer 504 would cause undesirable changes in capacitance.

In the stacked arrangement, drive electrode layer 504 including the drive electrodes and sense electrode layer 506 including the sense electrodes are arranged in an array of interacting electrodes comprising capacitive nodes (e.g., mutual capacitance nodes) at which changes in capacitance are sensed. In one or more examples, the horizontally-connected electrodes of drive electrode layer 504 (e.g., rows, driven by “X” or drive lines) correspond to changes that vary vertically (e.g., V0 through V7) to help determine the Y position. The vertically-connected electrodes of sense electrode layer 506 (e.g., columns, sensed at “Y” or sense lines) correspond to changes that vary horizontally (e.g., H0 through H7) to help determine the X position.

In contemplated operation with respect to capacitive touch-sensitive area 104, the touch controller is used to sequentially excite respective drive lines (e.g., X lines) with an AC voltage. At each capacitive node (e.g., intersection of an X-line and Y-line) a small mutual capacitance (Cₘ) is formed. When a finger touches at or near a node (e.g., a touch 610 of FIG. 6), it disturbs the electric field, reducing Cₘ at that point (e.g., part of the electric field couples to the human body). A capacitive coupling strength at each intersection may be detected at respective sense lines (e.g., Y lines). By scanning all intersections, the touch controller can map the exact touch location.

Note that touchscreens that utilize the capacitive touch sensor of FIGS. 5 and 6 often lack meaningful physical interaction or tactile feedback, and differ significantly from interfaces that incorporate physical buttons or tactile components. The primary distinction lies in how users perceive and interact with the system. A standard touchscreen relies solely on visual or auditory cues to confirm input, requiring users to look at the screen to verify their actions. In contrast, physical buttons or knobs provide tactile feedback - such as a click or resistance—which gives users immediate, non-visual confirmation that an input has been registered.

One of the main advantages of tactile feedback is that it allows users to operate controls by “feel.” This is particularly important in environments where visual attention must remain elsewhere, such as while driving. In such cases, physical interfaces allow users to perform actions without looking, improving safety and reducing cognitive load. The presence of defined physical boundaries in buttons or knobs also helps guide the user's hand, reducing accidental inputs and increasing accuracy. This makes tactile interfaces especially beneficial for people with motor impairments or in conditions where precise input is necessary.

Over time, physical interfaces allow users to develop muscle memory, enabling faster and more efficient interaction. For example, a user can quickly adjust volume or temperature using a knob without needing to process visual information. This efficiency and ease of use contribute to a more satisfying and trustworthy user experience. Furthermore, many users find the physical interaction itself more engaging and emotionally satisfying compared to touch-only controls.

While touchscreens offer greater flexibility and customization—as digital layouts can be changed easily—they may fall short in dynamic, mobile, or high-stakes environments. As a result, physical feedback remains a crucial element in many user interfaces. Hybrid solutions, such as the Knob on Display (KoD), aim to combine the adaptability of touchscreens with the intuitive control of physical interaction, delivering a more balanced and user-friendly experience.

FIG. 7 is a top-down view 700 of a multi-layer arrangement 702 of capacitive touch sensor 322 including one or more force regions 708 (e.g., a force region 710 and a force region 712), according to one or more examples of the disclosure. In one or more examples, one or more force regions 708 (e.g., force region 710 and/or force region 712) are examples of those regions that are a part of, or underlie, in FIGS. 1 and 2, one or more touchscreen buttons 106 (such as touchscreen button 108) and/or KoD device 112 (or other push button device).

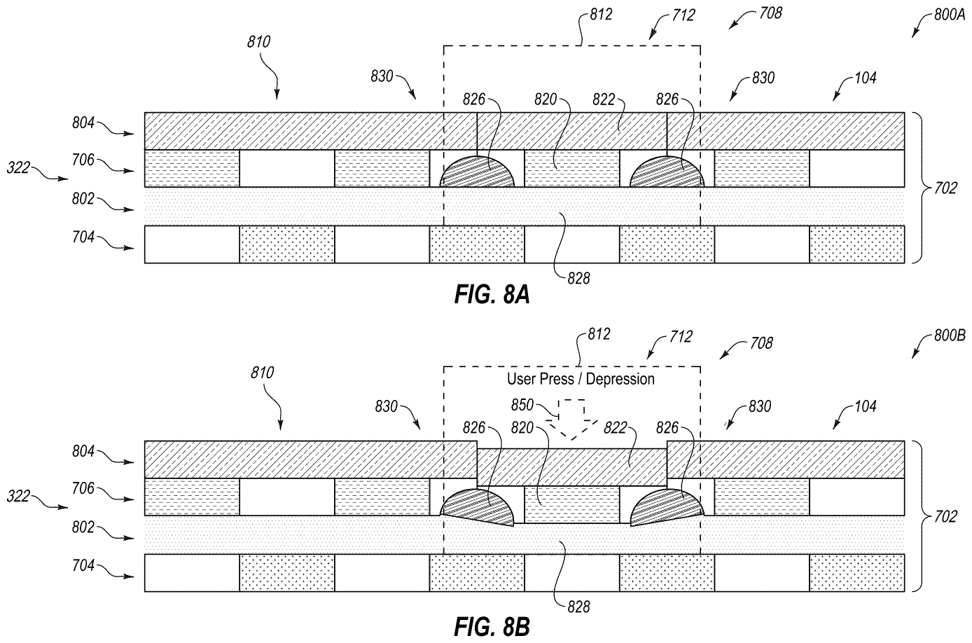

FIGS. 8A and 8B are respective cross-sectional views 800A and 800B of multi-layer arrangement 702 of capacitive touch sensor 322 of FIG. 7, according to one or more examples. Like capacitive touch sensor 322 of FIGS. 5 and 6, capacitive touch sensor 322 of FIGS. 7, 8A, and 8B is adapted for mutual capacitance touch detection, in one or more examples.

With reference to FIG. 7, multi-layer arrangement 702 of capacitive touch sensor 322 includes a drive electrode layer 704 including drive electrodes (e.g., indicated by horizontal hatching, or single-line or linear hatching, in FIG. 7) and a sense electrode layer 706 including sense electrodes (e.g., indicated by grid hatching, or cross or plus hatching, in FIG. 7). In FIG. 8A, it is shown that sense electrode layer 706 is stacked over drive electrode layer 704, with an insulating layer 802 (e.g., a dielectric layer) separating these layers, and a protective layer 804 (e.g., Perspex or glass, or even polymer film) formed over sense electrode layer 706. As is apparent, multi-layer arrangement 702 of capacitive touch sensor 322 includes a number of vertically-stacked layers (e.g., layers stacked in a direction that is perpendicular or normal to the page in FIG. 7, and in the Y-direction in FIGS. 8A and 8B).

In the stacked arrangement, drive electrode layer 704 including the drive electrodes and sense electrode layer 706 including the sense electrodes are arranged in an array of interacting electrodes comprising capacitive nodes (e.g., mutual capacitance nodes) at which changes in capacitance can be sensed. In one or more examples, the horizontally-connected electrodes of drive electrode layer 704 (e.g., rows, driven by “X” or drive lines in FIG. 7) correspond to changes that vary vertically (e.g., V0 through V7) to help determine the Y position. The vertically-connected electrodes of sense electrode layer 706 (e.g., columns, sensed at “Y” or sense lines in FIG. 7) correspond to changes that vary horizontally (e.g., H0 through H7) to help determine the X position.

In contemplated operation with respect to capacitive touch-sensitive area 104, the touch controller is used to sequentially excite respective drive lines (e.g., X lines) with a modulated or AC voltage. At each capacitive node (e.g., intersection of an X-line and Y-line) a small mutual capacitance (Cₘ) is formed. When a finger touches at or near a node (e.g., a touch 810 indicated in FIGS. 8A and 8B), it disturbs the electric field, reducing Cₘ at that point (e.g., part of the electric field couples to the human body). A capacitive coupling strength at each intersection is detected at respective sense lines (e.g., Y lines). By scanning all intersections, the touch controller can map the exact touch location. In response to touch 810 at a touch location, the measurements will indicate a reduction in capacitance at the intersection(s) associated with the touch location.

According to one or more examples, one or more force regions 708 are used for touchscreen buttons or physically-mounted buttons within capacitive touch-sensitive area 104 (e.g., in FIGS. 1 and 2, one or more touchscreen buttons 106, KoD device 112, and/or other push button device). One or more force regions 708 each comprise vertically-displaceable, sectioned portions of one or more vertically-stacked layers of multi-layer arrangement 702 of capacitive touch sensor 322.

For example, force region 712 is a vertically-displaceable, sectioned portion 812 (e.g., FIGS. 8A and 8B) of one or more vertically-stacked layers of multi-layer arrangement 702. In one or more examples, vertically-displaceable, sectioned portion 812 of force region 712 is mechanically isolated or separated from (e.g., albeit supported by or around) capacitive touch-sensitive area 104. In one or more examples, vertically-displaceable, sectioned portion 812 of force region 712 may be a vertically-displaceable, flexible, or compressible portion adapted to be vertically flexed, compressed, or otherwise displaced in responsive to a touch surface depression. In one or more examples, vertically-displaceable, sectioned portion 812 of force region 712 is sized to fit a fingertip, and is provided with a surface texture (e.g., on its outer surface) or haptics for tactile feedback (e.g., tactile or raised bumps or patterns).

In cross-sectional view 800A of FIG. 8A, vertically-displaceable, sectioned portion 812 of force region 712 is shown in a normal or rest position. In cross-sectional view 800B of FIG. 8B, vertically-displaceable, sectioned portion 812 of force region 712 is shown in a depressed position responsive to a touch surface depression 850. On the other hand, capacitive touch-sensitive area 104 outside of the force region(s) remains a substantially rigid, non-vertically-displaceable area 830.

In one or more examples, the one or more vertically-stacked layers of vertically-displaceable, sectioned portion 812 of force region 712 includes at least an electrode layer (e.g., sense electrode layer 706 of FIGS. 8A and 8B) of capacitive touch sensor 322. In one or more examples, the one or more vertically-stacked layers of vertically-displaceable, sectioned portion 812 of force region 712 include sense electrode layer 706 and protective layer 804 of capacitive touch sensor 322 (e.g., excluding drive electrode layer 704, which remains relatively firm upon touch surface depression). In one or more examples, the one or more vertically-stacked layers of vertically-displaceable, sectioned portion 812 of force region 712 includes an outer surface texture layer for tactile feedback (e.g., tactile or raised bumps or patterns).

In one or more examples, insulating layer 802 is a flexible or compressible adhesive (dielectric) layer. In one or more other examples, insulating layer 802 is an air gap layer (i.e., of open air). In one or more alternative examples, insulating layer 802 is a firm adhesive dielectric layer, where force region 712 is chemically treated to provide relatively increased compressibility for vertically-displaceable, sectioned portion 812 of force region 712.

In one or more examples, vertically-displaceable, sectioned portion 812 of force region 712 including sense electrode layer 706 is adapted to be flexed, compressed, or otherwise displaced toward drive electrode layer 704 (FIG. 8B) responsive to touch surface depression (or force). Thus, in one or more examples, capacitive node measurements for force detection indicate an increase in capacitance at force region 712 responsive to touch surface depression at force region 712. This observed increase in capacitance is in contrast to capacitive node measurements for capacitive touch detection for normal “touch” that indicate a reduction in capacitance. The increase in capacitance at force region 712 is caused since the sense and drive electrodes are moved physically closer to each other (e.g., the electrode-to-electrode coupling becomes stronger) and/or the dielectric thickness between the sense and drive electrodes becomes smaller.

In one or more examples, vertically-displaceable, sectioned portion 812 of force region 712 is provided with modifications in mechanical, structural, and/or compositional properties (e.g., in sense electrode layer 706 and protective layer 804) within vertically-displaceable, sectioned portion 812 to provide vertical displaceability (e.g., flexibility or compressibility). In one or more examples, one or more regions of capacitive touch sensor 322 may be mechanically scored and/or chemically treated (e.g., via etching or other selective removal process), for example, to form suspended cut-outs (e.g., a suspended cut-out portion 822 of protective layer 804 and/or a suspended cut-out portion 820 of sense electrode layer 706) and/or cut-outs or etched portions (e.g., cut-outs 826 of sense electrode layer 706) in multi-layer arrangement 702. For example, local treatments including wet etching or other selective removing of materials may be utilized to remove materials or reduce thicknesses in one or more layers (e.g., of glass, hardcoat, polymer, and so on). As another example, portions of materials of protective layer 804 and/or insulating layer 802 (e.g., a compressible portion 828 thereof) may be chosen to have a compressive modulus that lessens the material's stiffness or resistance to compression.

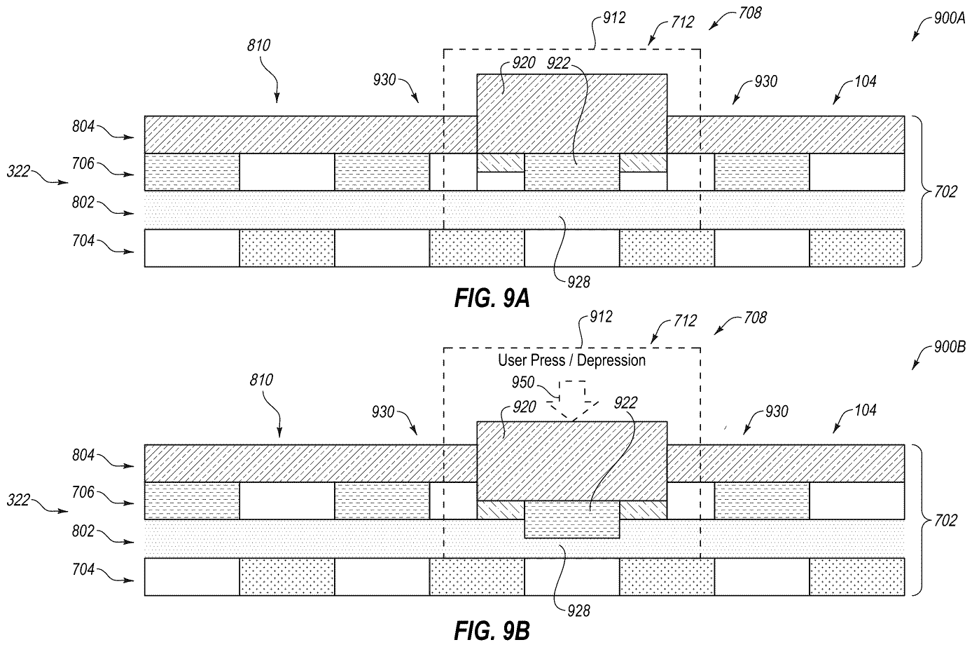

FIGS. 9A and 9B are respective cross-sectional views 900A and 900B of multi-layer arrangement 702 of capacitive touch sensor 322 of FIG. 7, according to one or more examples. Multi-layer arrangement 702 of FIGS. 9A and 9B is substantially the same as that shown and described in relation to multi-layer arrangement 702 of FIGS. 8A and 8B (e.g., including the same or similar functionality), except that force region 708 includes a vertically-displaceable, sectioned portion 912 according to one or more examples.

In one or more examples, vertically-displaceable, sectioned portion 912 of force region 712 of FIGS. 9A and 9B is a vertically-displaceable, flexible, or compressible portion adapted to be vertically flexed, compressed, or otherwise displaced in responsive to a touch surface depression. In one or more examples, vertically-displaceable, sectioned portion 912 of force region 712 is mechanically isolated or separated from (e.g., albeit supported by or around) capacitive touch-sensitive area 104. In cross-sectional view 900A of FIG. 9A, vertically-displaceable, sectioned portion 912 of force region 712 is shown in a normal or rest position. In cross-sectional view 900B of FIG. 9B, vertically-displaceable, sectioned portion 912 of force region 712 is shown in a depressed position responsive to a touch surface depression 950. On the other hand, capacitive touch-sensitive area 104 outside of the force region(s) remains a substantially rigid, non-vertically-displaceable area 930.

In one or more examples, vertically-displaceable, sectioned portion 912 of force region 712 including sense electrode layer 706 is adapted to be flexed, compressed, or otherwise displaced toward drive electrode layer 704 (FIG. 9B) responsive to touch surface depression (or force). Thus, in one or more examples, capacitive node measurements for force detection indicate an increase in capacitance at force region 712 responsive to touch surface depression at force region 712. Again, this observed increase in capacitance is in contrast to capacitive node measurements for capacitive touch detection for normal “touch” that indicate a reduction in capacitance. The increase in capacitance at force region 712 is caused as the sense and drive electrodes are moved physically closer to each other (e.g., the electrode-to-electrode coupling becomes stronger) and/or the dielectric thickness between the sense and drive electrodes becomes smaller.

In one or more examples, vertically-displaceable, sectioned portion 912 of force region 712 is provided with modifications in mechanical, structural, and/or compositional properties (e.g., in sense electrode layer 706 and protective layer 804) within vertically-displaceable, sectioned portion 812 to provide vertical displaceability (e.g., flexibility or compressibility). In one or more examples, one or more regions of capacitive touch sensor 322 may be mechanically scored and/or chemically treated (e.g., via etching or other selective removal process), for example, to form one or more cut-outs in protective layer 804 within which one or more button portions 920 are inserted. One or more button portions 920 may be formed over one or more sense electrode layer portions 922 in multi-layer arrangement 702. One or more button portions 820 may be considered vertically-guided button portions as depicted in FIGS. 9A and 9B. Prior to insertion of one or more button portions 920, local treatments including wet etching or other selective removing of materials are utilized to remove materials or reduce thicknesses (e.g., of glass, hardcoat, polymer, and so on). In one or more examples, one or more button portions 920 may be (e.g., at least slightly) raised over its surrounding protective layer 804 at least in the normal or rest position. As another example, portions of materials of protective layer 804 and/or insulating layer 802 (e.g., a compressible portion 928 thereof) may be chosen to have a compressive modulus that lessens the material's stiffness or resistance to compression.

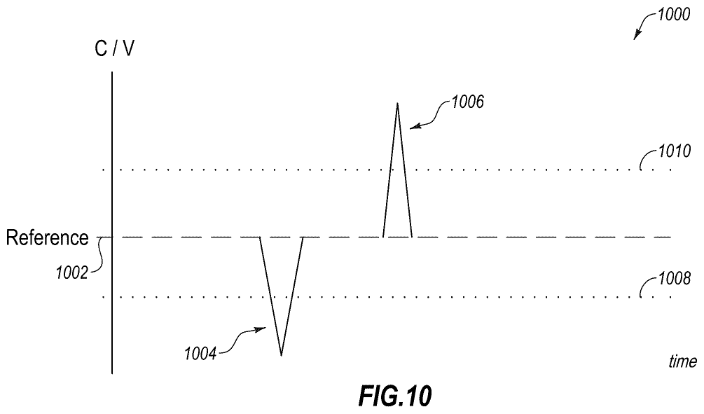

FIG. 10 is graph 1000 of capacitive node measurements relating to capacitance or voltage (C/V) over time for both capacitive touch detection and force detection, according to one or more examples. Measurements are depicted in relation to a reference level 1002.

In FIG. 10, capacitive node measurements 1004 for capacitive touch detection responsive to a touch indicate a reduction in capacitance or voltage. Here, capacitive node measurements 1004 for capacitive touch detection may indicate negative signal levels relative to reference level 1002. First capacitive nodes for a capacitive touch-sensitive area may be associated or assigned to processing for capacitive touch detection. For example, for detecting a touch event associated with a touch, one or more first voltage levels associated with capacitive node measurements 1004 from the first capacitive nodes may be received and determined to be outside a first limit set by a first threshold value 1008.

Also in FIG. 10, capacitive node measurements 1006 for force detection responsive to touch surface depression (e.g., force press at a force region) indicate an increase in capacitance or voltage. Here, capacitive node measurements 1006 for force detection may indicate positive signal levels relative to reference level 1002. Again, an increase in capacitance/voltage responsive to user depression at a force region is caused from sense electrodes moving physically closer to drive electrodes (e.g., the electrode-to-electrode coupling becomes stronger). Second capacitive nodes for a force region may be associated or assigned to processing for force detection. For example, for detecting a touch surface depression event associated with a touch surface depression (e.g., force press), one or more second voltage levels associated with capacitive node measurements 1006 from the second capacitive nodes may be received and determined to be outside a second limit set by a second threshold value 1010.

In one or more examples, first threshold value 1008 and second threshold value 1010 have opposite polarities (e.g., first threshold value 1008 is a negative value and second threshold value 1010 is a positive value). In one or more other examples, one of the first voltage levels or second voltage levels are inverted so that all voltage levels have the same polarity prior to comparison to the threshold(s). Other variations are realizable to one ordinarily skilled in the art.

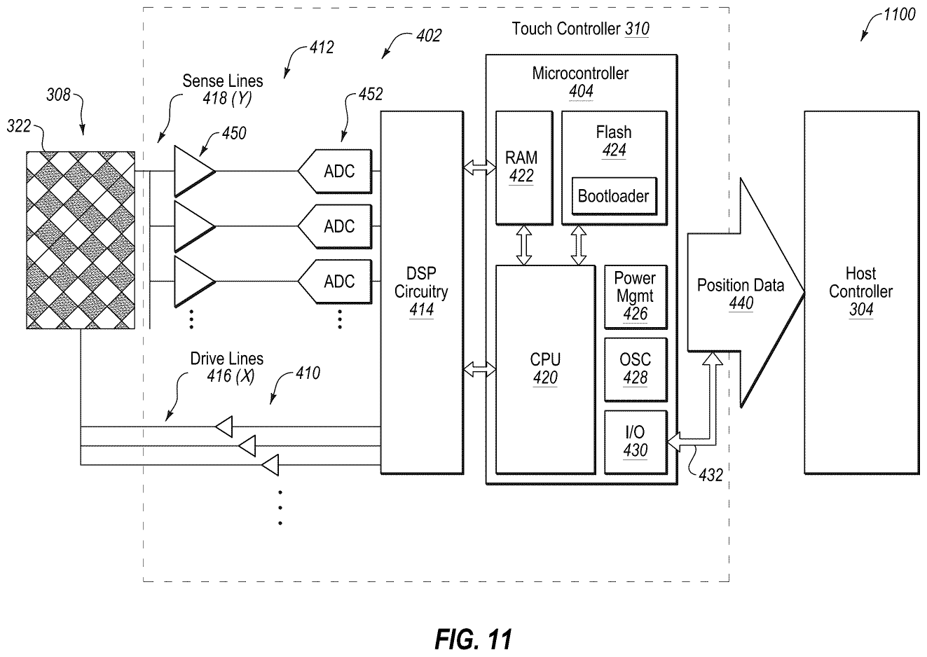

FIG. 11 is a schematic diagram of an apparatus 1100 including a capacitive touch system having touch controller 310 and capacitive touch sensor 322, according to one or more examples. Some of the features in FIG. 11 are the same as or similar to some of the features in FIGS. 3 and 4, as indicated by the same reference numbers, unless expressly described otherwise. In one or more examples, apparatus 1100 of FIG. 11 may be part of the touchscreen device 110 of FIG. 1. The capacitive touch system of apparatus 1100 of FIG. 11 may include some of the basic components of capacitive touch system 302 of FIG. 3, including the touchscreen (e.g., multi-layered I/O device 308 including at least capacitive touch sensor 322), the display circuitry (e.g., display circuitry 306 of FIG. 3), and host controller 304.

In one or more examples, touch controller 310 of FIG. 11 includes acquisition front end 402 for processing signals of capacitive touch sensor 322 for touch detection. In one or more examples, capacitive touch sensor 322 may include an array or grid of electrodes arranged in rows and columns (e.g., drive and sense electrodes in FIG. 7). Each intersection point between a row and a column of electrodes form a (capacitive) sensor node. The electrodes may be divided into two sets; a first set coupled to the number of drive lines 416 (e.g., rows or x-lines) of touch controller 310 and a second set coupled to the number of sense lines 418 (e.g., columns or y-lines) of touch controller 310. In one or more examples, drive circuitry 410 may be connected to the rows or x-lines (e.g., X0-X15 for rows 1-15), and sense circuitry 412 may be connected to the columns or y-lines (e.g., Y0-Y13 for columns 1-13).

In one or more examples, drive circuitry 410 includes a number of driver circuits respectively associated with the number of drive lines 416. In one or more examples, sense circuitry 412 includes a number of buffer circuits 450 (or, alternatively, for example, driver amplifier circuits or transimpedance amplifier circuits) and a number of analog-to-digital converters (ADCs) 452. The number of buffer circuits 450 is respectively associated with the number of sense lines 418. The number of buffer circuits 450 is respectively coupled to the number of ADCs 452, which are respectively coupled to inputs of DSP circuitry 414.

In contemplated operation, touch controller 310 may drive an electrical signal (or a “drive signal”) at each row of a sense electrode of capacitive touch sensor 322, e.g., sequentially, via the number of drive lines 416 using drive circuitry 410. The drive signal may be any suitable electrical signal, frequency signal, square wave, series of bursts or pulses, alternating voltage or current signals, and so on. Sense circuitry 412 may measure a mutual capacitance as a voltage at each column of a sense electrode of capacitive touch sensor 322, e.g., sequentially, via the number of sense lines 418. Based on the measurements, DSP circuitry 414 may detect changes in capacitance/voltage to detect a location of a touch.

On one hand, when a conductive object, such as a finger, approaches the touchscreen and makes contact with the surface thereof, the finger may form a capacitive coupling between drive and sense electrodes at the point of touch, thereby altering (e.g., lowering) the capacitance at the corresponding intersection point(s). The sense lines may measure the capacitance as a voltage at each of the sense electrodes. Changes in capacitance/voltage (e.g., indicating a decrease in capacitance/voltage) may be analyzed by DSP circuitry 414 to determine touch position data (e.g., the location of the touch), which may be communicated to CPU 420 and/or RAM 422 of microcontroller 404. In one or more examples, microcontroller 404 uses I/O interface circuitry 430 to communicate, at a communication process 440 (“Position Data”), the detected touch position data to host controller 304 via communication bus 330.

On the other hand, when an object, such as a finger or push button, approaches and contacts a force region (e.g., a vertically-displaceable, sectioned portion of the capacitive touch sensor) for user/button depression, sense and drive electrodes in the force region are moved physically closer to each other (e.g., the electrode-to-electrode coupling becomes stronger), thereby altering (e.g., increasing) the capacitance at the corresponding intersection point. The sense lines may measure the capacitance as a voltage at each of the sense electrodes. Changes in capacitance/voltage (e.g., indicating an increase in capacitance/voltage) may be analyzed by DSP circuitry 414 to determine force region or push button data (e.g., assigned value of force region or push button, the location of user/button depression, and so on), which may be communicated to CPU 420 and/or RAM 422 of microcontroller 404. In one or more examples, microcontroller 404 uses I/O interface circuitry 430 to communicate, at communication process 440 (“Position Data”), the force region or push button data to host controller 304 via communication bus 330.

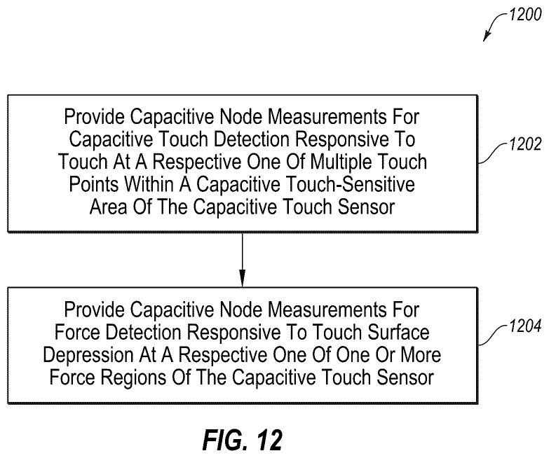

FIG. 12 is a flowchart of a method 1200 of a capacitive touch sensor, according to one or more examples. In one or more examples, method 1200 may be implemented using the capacitive touch sensor having features shown and described in relation to FIGS. 7, 8A, 8B, 9A, 9B, 10, 11, and/or 12.

At an act 1202 of method 1200, the capacitive touch sensor is to provide capacitive node measurements for capacitive touch detection responsive to touch at a respective one of multiple touch points within a capacitive touch-sensitive area of the capacitive touch sensor. At an act 1204 of method 1200, the capacitive touch sensor is to provide capacitive node measurements for force detection responsive to touch surface depression at a respective one of one or more force regions of the capacitive touch sensor.

In one of more examples of method 1200, respective ones of the one or more force regions comprise vertically-displaceable, sectioned portions of one or more vertically-stacked layers of the capacitive touch sensor. The respective ones of the vertically-displaceable, sectioned portions of the one or more vertically-stacked layers of the capacitive touch sensor comprise vertically-displaceable, flexible, or compressible portions adapted to be flexed, compressed, or otherwise displaced responsive to the touch surface depression. In one or more examples, the one or more vertically-stacked layers of the vertically-displaceable, sectioned portions include at least an electrode layer (e.g., a sense electrode layer) of the capacitive touch sensor.

In one of more examples of method 1200, the capacitive touch sensor comprises a multi-layered arrangement including a drive electrode layer including drive electrodes; a sense electrode layer including sense electrodes, the drive electrode layer and the sense electrode layer arranged to provide an array of interacting electrodes comprising capacitive nodes at which changes in capacitance are sensed; and the one or more force regions comprise vertically-displaceable, sectioned portions of at least the sense electrode layer.

In one of more examples of method 1200, the capacitive touch-sensitive area of the capacitive touch sensor is a substantially rigid, non-vertically-displaceable area; and respective ones of the vertically-displaceable, sectioned portions are within the capacitive touch-sensitive area and adapted to be flexed, compressed, or otherwise displaced toward the drive electrode layer, relative to the capacitive touch-sensitive area, responsive to touch surface depression.

In one of more examples of method 1200, in act 1202, the capacitive node measurements for the capacitive touch detection responsive to the touch indicate a reduction in capacitance at the respective one of multiple touch points, and in act 1204, the capacitive node measurements for the force detection responsive to the touch surface depression indicate an increase in capacitance at the respective one of the one or more force regions.

In one or more examples of method 1200, the capacitive touch sensor is operably coupled to a touch controller which is to receive the capacitive node measurements; detect, at least partially based on the capacitive node measurements, a touch event responsive to the touch at the respective one of the multiple touch points within the capacitive touch-sensitive area; and detect, at least partially based on the capacitive node measurements, a touch surface depression event responsive to the touch surface depression at the respective one of the one or more force regions.

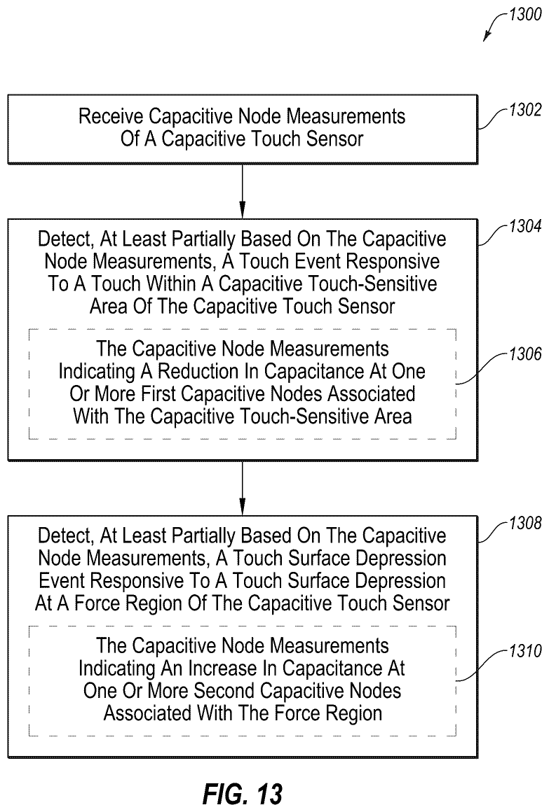

FIG. 13 is a flowchart of a method 1300 of a touch controller, according to one or more examples. In one or more examples, method 1300 may be implemented using the touch controller 310 shown and described in relation to FIGS. 3, 4, 11, and 13, with operative coupling to the capacitive touch sensor having features shown and described in relation to FIGS. 7, 8A, 8B, 9A, 9B, 10, and/or 12.

At an act 1302 of method 1300, capacitive node measurements of a capacitive touch sensor are received. At an act 1304, a touch event responsive to a touch within a capacitive touch-sensitive area of the capacitive touch sensor is detected at least partially based on the capacitive node measurements. At an act 1304 of method 1300, a touch surface depression event responsive to a touch surface depression at a force region of the capacitive touch sensor is detected at least partially based on the capacitive node measurements.

In one or more examples of method 1300, detecting the touch event in act 1304 comprises, at an act 1306, the capacitive node measurements indicating a reduction in capacitance at one or more first capacitive nodes associated with the capacitive touch-sensitive area; and detecting the touch surface depression event in act 1308 comprises, at an act 1310, the capacitive node measurements indicating an increase in capacitance at one or more second capacitive nodes associated with the force region.

In one or more examples of method 1300, the force region of the capacitive touch sensor comprises a vertically-displaceable, sectioned portion of one or more vertically-stacked layers of the capacitive touch sensor. The vertically-displaceable, sectioned portion of the one or more vertically-stacked layers of the capacitive touch sensor comprises a vertically-displaceable, flexible, or compressible portion adapted to be flexed, compressed, or otherwise displaced responsive to the touch surface depression.

In one or more examples of method 1300, the capacitive touch sensor includes a drive electrode layer and a sense electrode layer. The drive electrode layer and the sense electrode layer are arranged to provide an array of interacting electrodes comprising capacitive nodes at which changes in capacitance are sensed.

In one or more examples of method 1300, detecting the touch event in act 1304 comprises, for one or more first capacitive nodes associated with the capacitive touch-sensitive area: receiving one or more first voltage levels associated with first capacitive node measurements from the one or more first capacitive nodes and determining that the one or more first voltage levels are outside a first limit set by a first threshold value; and detecting the touch surface depression event in act 1308 comprises, for one or more second capacitive nodes associated with the force region: receiving one or more second voltage levels associated with second capacitive node measurements from the one or more second capacitive nodes and determining that the one or more second voltage levels are outside a second limit set by a second threshold value. In one or more examples, the first threshold value and the second threshold value have opposite polarities (e.g., the first threshold value is a negative value and the second threshold value is a positive value).

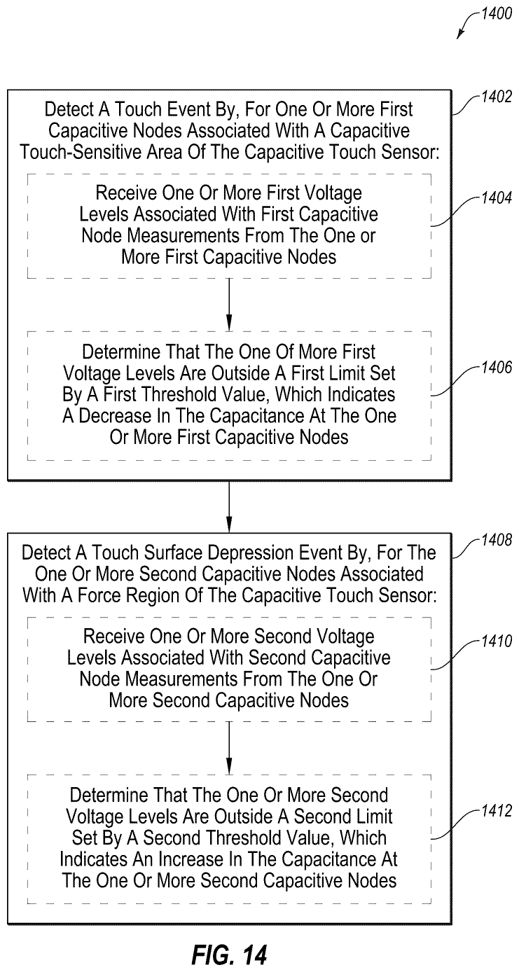

FIG. 14 is a flowchart of a method 1400 of a touch controller, according to one or more examples. In one or more examples, method 1400 may be implemented using the touch controller 310 shown and described in relation to FIGS. 3, 4, 11, and 13, with operative coupling to the capacitive touch sensor having features shown and described in relation to FIGS. 7, 8A, 8B, 9A, 9B, 10, and/or 12.

More particularly, in one or more examples of method 1400, the touch controller includes one or more processors, a number of transmit lines for coupling to drive electrodes of a drive electrode layer of a capacitive touch sensor, and a number of receive lines for coupling to sense electrodes of a sense electrode layer of the capacitive touch sensor. The one or more processors of the touch controller are executable to perform method 1400 of FIG. 14. The sense electrode layer and the drive electrode layer are arranged to provide an array of interacting electrodes comprising capacitive nodes. A drive circuitry is coupled to the one or more processors and to the number of transmit lines, and is adapted to drive modulated signals to the drive electrodes via respective ones of the number of transmit lines. A sense circuitry is coupled to the one or more processors and the number of receive lines, and is adapted to sense capacitive node measurements from the sense electrodes via the respective ones of the number of receive lines.

At an act 1402 of method 1400, a touch event is detected. The touch event may be detected by, for one or more first capacitive nodes associated with a capacitive touch-sensitive area of the capacitive touch sensor: receiving, at an act 1404, one or more first voltage levels associated with first capacitive node measurements from the one or more first capacitive nodes; and determining, at an act 1406, that the one or more first voltage levels are outside a first limit set by a first threshold value, which indicates a decrease in the capacitance at the one or more first capacitive nodes.

At an act 1408 of method 1400, a touch surface depression event is detected. The touch surface depression event may be detected by, for one or more second capacitive nodes associated with a vertically-displaceable, sectioned portion of the capacitive touch sensor: receiving, at an act 1410, one or more second voltage levels associated with second capacitive node measurements from the one or more second capacitive nodes; and determining, at an act 1412, that the one or more second voltage levels are outside a second limit set by a second threshold value, which indicates the increase in the capacitance at the one or more second capacitive nodes.

In one or more examples of method 1400, the first threshold value and the second threshold value have opposite polarities (e.g., the first threshold value is a negative value and the second threshold value is a positive value).

In one or more examples of method 1400, the vertically-displaceable, sectioned portion is in one or more vertically-stacked layers of the capacitive touch sensor. The vertically-displaceable, sectioned portion is adapted to be flexed, compressed, or otherwise displaced responsive to a touch surface depression.

In one of more examples of method 1400, the capacitive touch-sensitive area of the capacitive touch sensor is a substantially rigid, non-vertically-displaceable area. The vertically-displaceable, sectioned portion is of at least the sense electrode layer of the capacitive touch sensor. The vertically-displaceable, sectioned portion is within the capacitive touch-sensitive area and adapted to be flexed, compressed, or otherwise displaced toward the drive electrode layer, relative to the capacitive touch-sensitive area, responsive to touch surface depression.

FIGS. 15A and 15B depict respective cross-sectional views 1500A and 1500B of a push button device 1510 for a touchscreen 1502, according to one or more examples. Here, touchscreen 1502 includes a capacitive touch sensor including a force region 1506 (e.g., a vertically-displaceable, sectioned portion) according to one or more examples (e.g., FIGS. 7, 8A, 8B, 9A, 9B, and 10-14). In cross-sectional view 1500A of FIG. 15A, push button device 1510 is shown in a normal or rest position. In cross-sectional view 1500B of FIG. 15B, push button device 1510 is shown in a depressed position responsive to a vertical button depression 1550.

Push button device 1510 includes a top surface portion 1512, a bottom surface portion 1517, and a pressure pad member 1516. In one or more examples, top surface portion 1512 is a plate and bottom surface portion 1517 is a supporting wall structure that connects to and supports the plate. Bottom surface portion 1517 is to mount (e.g., fixedly mount, via adhesive or otherwise) to a surface 1504 of touchscreen 1502.

Pressure pad member 1516 has a first (top) end connected to top surface portion 1512 (e.g., substantially in a center of push button device 1510) and a second (bottom) end having a bottom surface 1518 (e.g., a pressure pad) that faces the surface of force region 1506 of touchscreen 1502. In the fixed mounting of push button device 1510 to surface 1504 of touchscreen 1502, bottom surface 1518 (e.g., the pressure pad) of pressure pad member 1516 is aligned with force region 1506.

In frontal view, push button device 1510 may have any one of a variety of different shapes, such as a circular shape (e.g., like KoD device 112 in FIG. 1), a polygonal shape, a square shape, a triangular shape, and so on. Push button device 1510 may be made of any one or more of a variety of plastic materials, such as rigid and/or flexible plastic materials, including materials such as polycarbonate, nylon, acrylonitrile butadiene styrene (ABS), polypropylene, and so on, or other materials. In one or more examples, push button device 1510 is integrally-formed as a single unit. For example, push button device 1510 may be made as a monolithic part or a single-shot injection-molded part.

In one or more examples, top surface portion 1512 of push button device 1510 can be flexibly displaced vertically at and around its center due to elastic deformation. Such flexibility of top surface portion 1512 may be achieved with use of appropriate plastic property materials and thickness. In one or more examples, the volume that surrounds pressure pad member 1516 is void of any materials (e.g., it may be open air), or alternatively, is provided with a relatively flexible or compressible material.

In one or more examples, push button device 1510 includes pressure pad member 1516 with its bottom surface 1518 for force-based activation. In one or more examples, push button device 1510 excludes the use of conductive materials (e.g., no conductive pads) for touch activation (e.g., bottom surface 1518 of pressure pad member 1516 may be made (e.g., solely) of plastic materials and/or exclude conductive materials for touch activation).

In the normal position of push button device 1510 depicted in FIG. 15A, bottom surface 1518 of pressure pad member 1516 merely rests on top of (or is alternatively positioned a short distance away from) the surface of force region 1506. In the depressed position of push button device 1510 depicted in FIG. 15B, a user depresses top surface portion 1512 of push button device 1510 (e.g., vertical button depression 1550, at its center) such that pressure pad member 1516 vertically extends from bottom surface portion 1517 towards force region 1506.

In one or more examples, the vertical extension is achieved through elastic deformation of top surface portion 1512 relative to the (e.g., rigid) wall structure of bottom surface portion 1517. In one or more examples, the center of top surface portion 1512 experiences maximum deflection or displacement perpendicular to the original plane of top surface portion 1512 in its normal position. In the depressed position, top surface portion 1512 deforms into a curved shape with peak curvature occurring at its center. Here, bottom surface 1518 (e.g., the pressure pad) of pressure pad member 1516 vertically extends toward force region 1506 of touchscreen 1502 to apply force or pressure to force region 1506.

Accordingly, pressure pad member 1516 vertically extends from bottom surface portion 1517, responsive to the depression of top surface portion 1512, to cause touch surface depression (force) at force region 1506. In one or more examples, force region 1506 is associated or assigned with force detection processing for detection of a touch surface depression event associated with an increase in capacitance (e.g., acts 1308 and 1310 of FIG. 13 and/or act 1408 of FIG. 14 including acts 1410 and 1412).

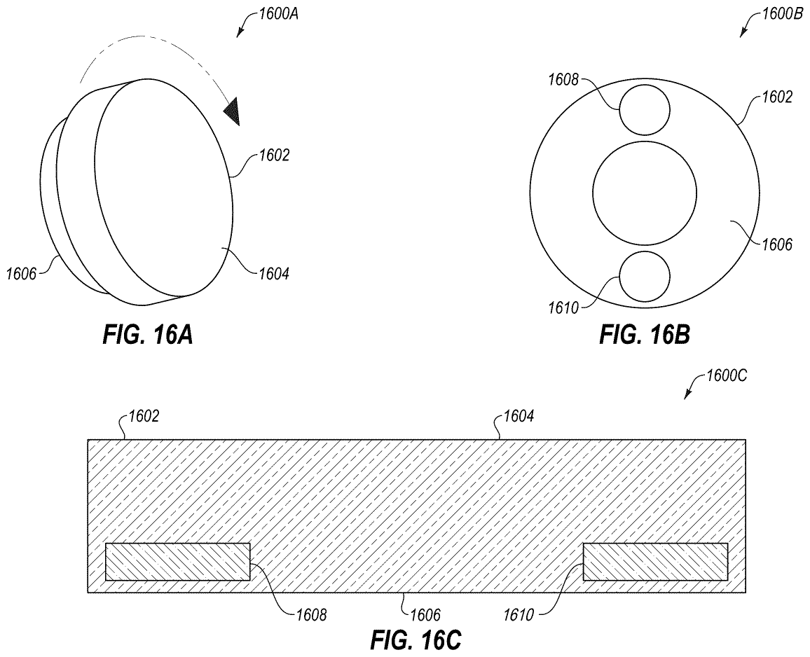

FIGS. 16A, 16B, and 16C are respective views of a Knob-on-Display (KoD) device 1602 that is known by the inventor of this disclosure. In particular, FIG. 16A is a perspective view 1600A of KoD device 1602, FIG. 16B is a bottom side view 1600B of KoD device 1602, and FIG. 16C is a cross-sectional view 1600C of KoD device 1602.

In general, KoD device 1602 is a user interface component designed to mount to a touchscreen, combining physical control via a rotary knob 1604 with capacitive touch sensing via conductive pads 1608 and 1610 (e.g., on a bottom surface 1606 of KoD device 1602). In one or more examples, rotary knob 1604 of KoD device 1602 provides a physical rotary input that allows a user to turn or rotate to control parameters of the touchscreen device. KoD device 1602 may provide rotary knob 1604 with detents (e.g., clicking stops) for tactile feedback.

Conductive pads 1608 and 1610 (e.g., metal or conductive rubber) are located underneath or around the base of the knob, and may make capacitive contact (without physical contact) with the touchscreen. Conductive pads 1608 and 1610 may simulate fingertip touchpoints on the touchscreen surface, as well as allow the touchscreen to detect the knob's presence and orientation. As rotary knob 1604 is rotated, the position of conductive pads 1608 and 1610 changes relative to the touchscreen, which operates to track the movement of the pads to determine the rotation angle and direction. The design of KoD device 1602 offers a cost-effective and intuitive input method, especially useful in automotive, audio, and industrial interfaces.

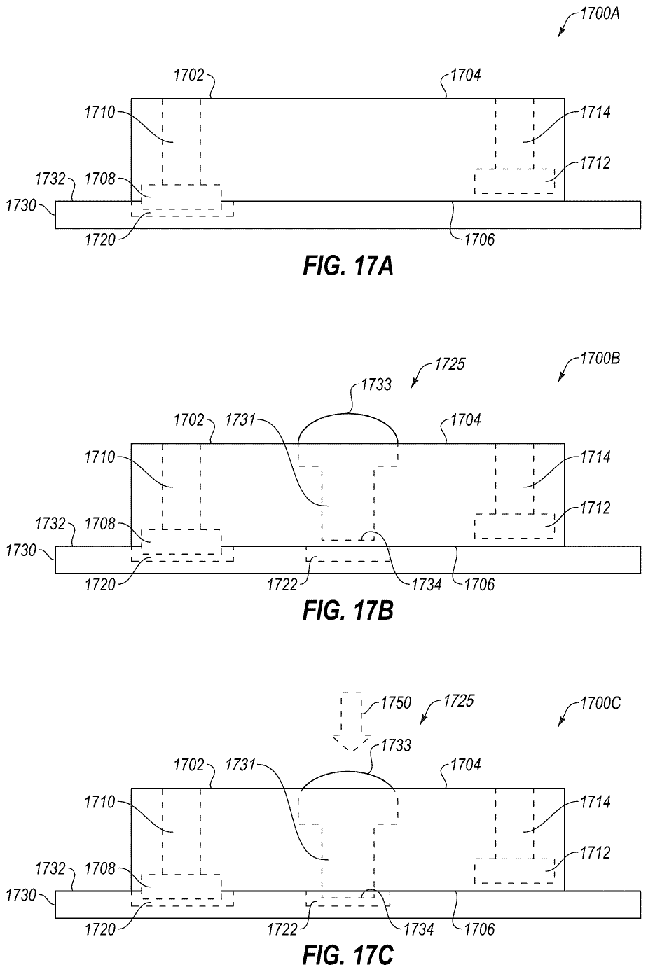

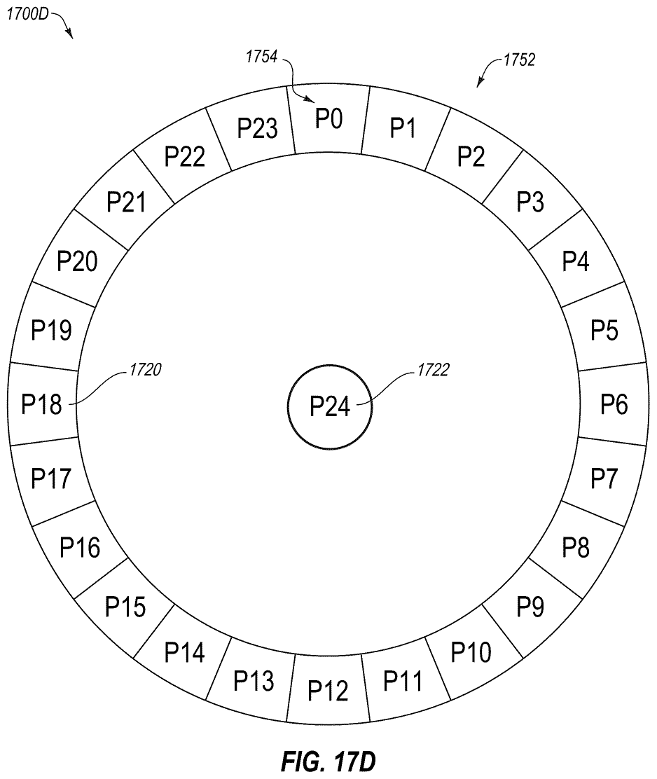

FIG. 17A depicts a cross-sectional view 1700A of a KoD device 1702 for a touchscreen 1730, according to one or more examples. For compatibility with KoD device 1702, touchscreen 1730 includes a capacitive touch sensor having a number of force regions (e.g., including a force region 1720) comprising vertically-displaceable, sectioned portions of the capacitive touch sensor, according to one or more examples (e.g., FIGS. 7, 8A, 8B, 9A, 9B, and 10-14). In one or more examples, force region 1720 is one of a number of different force regions arranged in an annulus of the capacitive touch sensor, an example of which is shown and described later in relation to FIG. 17D (e.g., force region 1720 arranged in an annulus 1752 of FIG. 17D).

In frontal view, KoD device 1702 may have any one of a variety of different shapes, such as a circular shape for rotational positioning (e.g., like KoD device 112 in FIGS. 1 and 2), a polygonal shape, a square shape, a triangular shape, and so on. KoD device 1702 may be made of any one or more of a variety of plastic materials, such as rigid and/or flexible plastic materials, including materials such as polycarbonate, nylon, ABS, polypropylene, and so on, or other materials.

FIGS. 17B and 17C depict respective cross-sectional views 1700B and 1700C of KoD device 1702 of FIG. 17A to further include a push button device 1725, according to one or more examples. For compatibility with KoD device 1702 of FIGS. 17B and 17C, touchscreen 1730 includes a capacitive touch sensor having another force region 1722 (e.g., a vertically-displaceable, sectioned portion), according to one or more examples (e.g., FIGS. 7, 8A, 8B, 9A, 9B, and 10-14). In one or more examples, the other force region 1722 is substantially in a center of the annulus of force regions of the capacitive touch sensor, as depicted in the example shown and described later in relation to FIG. 17D (e.g., force region 1722 arranged substantially in a center of annulus 1752 of FIG. 17D). In cross-sectional view 1700B of FIG. 17B, push button device 1725 of KoD device 1702 is shown in a normal or rest position. In cross-sectional view 1700C of FIG. 17C, push button device 1725 of KoD device 1702 is shown in a depressed position responsive to a vertical button depression 1750.

With reference back to FIG. 17A, KoD device 1702 includes a top surface portion 1704, a bottom surface portion 1706, and a pressure pad member 1710. In one or more examples, top surface portion 1704 and bottom surface portion 1706 are configured as a rotary knob including a mounting structure to mount (e.g., fixedly mount, via adhesive or otherwise) to a surface 1732 of touchscreen 1730. In one or more examples, KoD device 1702 may also include a member 1714 including a pad 1712, where member 1714 is situated opposite that of pressure pad member 1710.

Pressure pad member 1710 has a first (top) end connected to top surface portion 1704 and a second (bottom) end having a bottom surface including a pressure pad 1708. In the fixed mounting of KoD device 1702 to surface 1732 of touchscreen 1730, pressure pad 1708 is aligned with, faces, and applies force or pressure to the surface of force region 1720. More particularly, pressure pad member 1710 is adapted to rotate, responsive to rotation of the rotary knob (e.g., see arrow of rotation of KoD device 1602 of FIG. 16A), to apply substantially constant touch surface depression at respective different ones of the number of force regions (such as force region 1720) arranged in the annulus.

FIG. 17D is frontal view 1700D of a number of force regions 1754 (including force region 1720) arranged in annulus 1752 of the capacitive touch sensor, according to one or more examples. In one or more examples, the number of force regions 1754 are provided as predefined regions within annulus 1752, and more particularly as predefined arc regions P0, P1, P2, P3, P4, P5, P6, P7, P8, P9, P10, P11, P12, P13, P14, P15, P16, P17, P18, P19, P20, P21, P22, and P23 (i.e., twenty-four (24) regions for twenty-four (24) angular positions). As described herein, these predefined regions may be different vertically-displaceable, sectioned portions of the capacitive touch sensor, and associated or assigned with force detection processing for detection of touch surface depression events. In one or more examples, a number of angular position values are respectively associated with the number of force regions 1754, and indicate discrete angular positions around annulus 1752 (e.g., discrete angular positions associated with positions P0, P1, P2, P3, P4, P5, P6, P7, P8, P9, P10, P11, P12, P13, P14, P15, P16, P17, P18, P19, P20, P21, P22, and P23).

Again, KoD device 1702 of FIG. 17A includes pressure pad member 1710 including pressure pad 1708 adapted to rotate, responsive to rotation of the rotary knob, to apply substantially constant touch surface depression (or force) at respective different ones of force regions 1754 arranged in annulus 1752. In FIG. 17D, respective ones of the number of force regions 1754 are associated or assigned with force detection processing for detection of touch surface depression events (i.e., using KoD device 1702) associated with an increase in capacitance (e.g., acts 1308 and 1310 of FIG. 13 and/or act 1408 of FIG. 14 including acts 1410 and 1412). In response to touch position data corresponding to an identified one of the number of force regions 1754 of annulus 1752, capacitive touch processing is to select one of the number of angular position values (e.g., discrete angular positions associated with positions P0, P1, P2, P3, P4, P5, P6, P7, P8, P9, P10, P11, P12, P13, P14, P15, P16, P17, P18, P19, P20, P21, P22, or P23) that correspond to the identified one of the number of force regions 1754. The touch controller may send the detected angular position value (or other suitable indicator) to the host processor, and the host processor may perform a predetermined function (e.g., such as a context-based function) in response to the detected angular position value. For example, KoD device 1702 may allow the user to turn or rotate the rotary knob to control parameters of the device (e.g., volume, brightness, scrolling, and so on).

As is apparent, the design of KoD device 1702 of the disclosure also offers a cost-effective and intuitive input method (as compared to KoD device 1602 of FIGS. 16A, 16B, and 16C), especially useful in automotive, audio, and industrial interfaces, without the need for conductive pads or materials.

With reference back to FIGS. 17B and 17C, touchscreen 1730 includes the capacitive touch sensor having the other force region 1722 substantially in the center of the annulus (e.g., in FIG. 17D, other force region 1722 substantially in the center of annulus 1752) for compatibility with KoD device 1702 including push button device 1725.

In cross-sectional view 1700B of FIG. 17B, push button device 1725 of KoD device 1702 is shown in the normal or rest position. Pressure pad member 1731 has a first (top) end connected to top surface portion 1733 (e.g., substantially in a center of push button device 1725) and a second (bottom) end having a bottom surface 1734 (e.g., a pressure pad) that faces the surface of force region 1722 of touchscreen 1730. In the fixed mounting of KoD device 1702 to surface 1732 of touchscreen 1730, bottom surface 1734 (e.g., the pressure pad) of pressure pad member 1710 is aligned with force region 1722.

Push button device 1725 includes pressure pad member 1731 with its bottom surface 1734 for force-based activation. In one or more examples, push button device 1725 excludes the use of conductive materials (e.g., no conductive pads) for touch activation (e.g., bottom surface 1734 of pressure pad member 1731 may be made (e.g., solely) of plastic materials and/or exclude conductive materials for touch activation). In one or more examples, push button device 1725 is a spring-loaded device (e.g., including a spring assembly) that can be displaced in a vertical direction with use of one or more springs.

In the normal or rest position of push button device 1725 depicted in FIG. 17B, bottom surface 1734 of pressure pad member 1731 merely rests on top of (or is alternatively positioned a short distance away from) the surface of force region 1722. In the depressed position of push button device 1725 depicted in FIG. 17C, a user depresses top surface portion 1733 of push button device 1725 (e.g., vertical button depression 1750, at its center) such that pressure pad member 1731 (e.g., its bottom surface 1734) vertically extends from bottom surface portion 1706 towards force region 1722. Here, bottom surface 1734 (e.g., the pressure pad) of pressure pad member 1731 vertically extends toward force region 1722 of touchscreen 1730 to apply force or pressure to force region 1722.

Accordingly, pressure pad member 1731 vertically extends from bottom surface portion 1706, responsive to the depression of top surface portion 1733, to cause touch surface depression (force) at force region 1722. In one or more examples, force region 1722 is associated or assigned with force detection processing for detection of a touch surface depression event associated with an increase in capacitance (e.g., act 1310 of FIG. 13 and/or act 1412 of FIG. 14). The touch controller may send a push button value (e.g., mode select or other suitable indicator) to the host processor, and the host processor may perform a predetermined function (e.g., such as a context-based function) in response to the push button value.

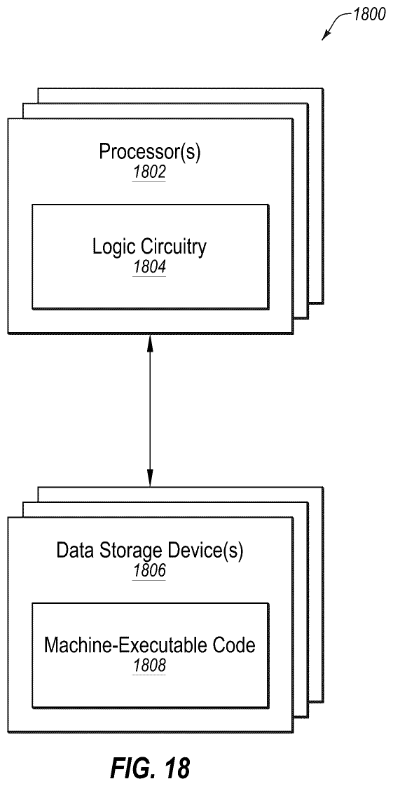

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 18 illustrates non-limiting examples of implementations of functional elements disclosed herein. In some examples, some or all portions of the functional elements disclosed herein may be performed by hardware specially implemented for carrying out the functional elements.

FIG. 18 is a block diagram of circuitry 1800 that, in some examples, may be used to implement various functions, operations, acts, processes, and/or methods disclosed herein. In one or more examples, circuitry 1800 may be part of a computing device (e.g., a touchscreen device, such as touchscreen device 110 of FIG. 1). Circuitry 1800 includes one or more processors 1802 (sometimes referred to herein as “processors 1802”) operably coupled to one or more data storage devices (sometimes referred to herein as “storage 1806”). Storage 1806 includes machine-executable code 1808 stored thereon and processors 1802 include a logic circuitry 1804. Machine-executable code 1808 includes information describing functional elements that may be implemented by (e.g., performed by) logic circuitry 1804. Logic circuitry 1804 is adapted to implement (e.g., perform) the functional elements described by machine-executable code 1808. Circuitry 1800, when executing the functional elements described by machine-executable code 1808, should be considered as special purpose hardware for carrying out functional elements disclosed herein. In some examples, processors 1802 may perform the functional elements described by machine-executable code 1808 sequentially, concurrently (e.g., on one or more different hardware platforms), or in one or more parallel process streams.

When implemented by logic circuitry 1804 of processors 1802, machine-executable code 1808 adapts processors 1802 to perform operations of examples disclosed herein. For example, machine-executable code 1808 may adapt processors 1802 to perform at least a portion or a totality of the methods or processes described herein. In one or more examples, machine-executable code 1808 may adapt processors 1802 to perform at least a portion or a totality of the methods or processes associated with the methodologies described in relation to FIGS. 12, 13, and/or 14.

Processors 1802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1808 (e.g., software code, firmware code, hardware descriptions) related to examples of the present disclosure. It is noted that a general-purpose processor (may also be referred to herein as a host processor or simply a host) may be a microprocessor, but in the alternative, processors 1802 may include any conventional processor, controller, microcontroller, or state machine. Processors 1802 may also be implemented as a combination of computing devices, such as a combination of a DSP and a microprocessor, a plurality of microprocessors, one or more microprocessors in conjunction with a DSP core, or any other such configuration.

In some examples, storage 1806 includes volatile data storage (e.g., random-access memory (RAM)), non-volatile data storage (e.g., Flash memory, a hard disc drive, a solid state drive, erasable programmable read-only memory (EPROM), etc.). In some examples, processors 1802 and storage 1806 may be implemented into a single device (e.g., a semiconductor device product, a system on chip (SoC), etc.). In some examples, processors 1802 and storage 1806 may be implemented into separate devices.

In some examples, machine-executable code 1808 may include computer-readable instructions (e.g., software code, firmware code). By way of non-limiting example, the computer-readable instructions may be stored by storage 1806, accessed directly by processors 1802, and executed by processors 1802 using at least logic circuitry 1804. Also by way of non-limiting example, the computer-readable instructions may be stored on storage 1806, transferred to a memory device (not shown) for execution, and executed by processors 1802 using at least logic circuitry 1804. Accordingly, in some examples, logic circuitry 1804 includes electrically configurable logic circuitry 1804.

In some examples, machine-executable code 1808 may describe hardware (e.g., circuitry) to be implemented in logic circuitry 1804 to perform the functional elements.

This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog, or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1804 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1808 may include an HDL, an RTL, a GL description, a mask level description, other hardware description, or any combination thereof.

In examples where machine-executable code 1808 includes a hardware description (at any level of abstraction), a system (not shown, but including storage 1806) may implement the hardware description described by machine-executable code 1808. By way of non-limiting example, processors 1802 may include a programmable logic device (e.g., an FPGA or a PLC) and logic circuitry 1804 may be electrically controlled to implement circuitry corresponding to the hardware description into logic circuitry 1804. Also by way of non-limiting example, logic circuitry 1804 may include hard-wired logic manufactured by a manufacturing system (not shown, but including storage 1806) according to the hardware description of machine-executable code 1808.

Regardless of whether machine-executable code 1808 includes computer-readable instructions or a hardware description, logic circuitry 1804 is adapted to perform the functional elements described by machine-executable code 1808 when implementing the functional elements of machine-executable code 1808. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.
Example 1: An apparatus comprising: a capacitive touch sensor to: provide first capacitive node measurements for capacitive touch detection responsive to touch at a respective one of multiple touch points within a capacitive touch-sensitive area of the capacitive touch sensor, the first capacitive node measurements indicating a reduction in capacitance at one or more first capacitive nodes of the capacitive touch sensor; and provide second capacitive node measurements for force detection responsive to touch surface depression at a respective one of one or more force regions of the capacitive touch sensor, the second capacitive node measurements indicating an increase in capacitance at one or more second capacitive nodes of the capacitive touch sensor.
Example 2: The apparatus according to Example 1, wherein: the capacitive touch sensor comprises a number of vertically-stacked layers; and respective ones of the one or more force regions comprise vertically-displaceable, sectioned portions of one or more vertically-stacked layers of the capacitive touch sensor.
Example 3: The apparatus according to Examples 1 and 2, wherein: the respective ones of the one or more force regions comprising the vertically-displaceable, sectioned portions comprise vertically-displaceable, flexible, or compressible portions adapted to be flexed, compressed, or otherwise displaced responsive to the touch surface depression.
Example 4: The apparatus according to any of Examples 1 to 3, wherein: the one or more vertically-stacked layers of the vertically-displaceable, sectioned portions include at least an electrode layer of the capacitive touch sensor.
Example 5: The apparatus according to any of Examples 1 to 4, wherein: the number of vertically-stacked layers of the capacitive touch sensor include: a drive electrode layer including drive electrodes; a sense electrode layer including sense electrodes, the drive electrode layer and the sense electrode layer arranged to provide an array of interacting electrodes comprising capacitive nodes at which changes in capacitance are sensed; and the one or more vertically-stacked layers of the vertically-displaceable, sectioned portions include at least the sense electrode layer.
Example 6: The apparatus according to any of Examples 1 to 5, wherein: the capacitive touch-sensitive area of the capacitive touch sensor is a substantially rigid, non-perpendicularly-displaceable area; and respective ones of the vertically-displaceable, sectioned portions of the one or more vertically-stacked layers of the capacitive touch sensor are mechanically isolated or separated from the capacitive touch-sensitive area and adapted to be flexed, compressed, or otherwise displaced toward the drive electrode layer, relative to the capacitive touch-sensitive area, responsive to touch surface depression.
Example 7: The apparatus according to any of Examples 1 to 6, wherein: the number of vertically-stacked layers of the capacitive touch sensor include an insulating layer between the drive electrode layer and the sense electrode layer; and the one or more vertically-stacked layers of the vertically-displaceable, sectioned portions include at least the sense electrode layer and the insulating layer, the insulating layer of the vertically-displaceable, sectioned portions comprising a flexible, compressible, or air gap layer.
Example 8: The apparatus according to any of Examples 1 to 7, comprising: a touch controller to: receive the first capacitive node measurements; detect, at least partially based on the first capacitive node measurements indicating the reduction in capacitance, a touch event responsive to the touch at the respective one of the multiple touch points within the capacitive touch-sensitive area; receive the second capacitive node measurements; and detect, at least partially based on the second capacitive node measurements indicating the increase in capacitance, a touch surface depression event responsive to the touch surface depression at the respective one of the one or more force regions.
Example 9: An apparatus comprising: a capacitive touch sensor comprising a number of vertically-stacked layers including: a drive electrode layer including drive electrodes; a sense electrode layer including sense electrodes, the drive electrode layer and the sense electrode layer arranged to provide an array of interacting electrodes comprising capacitive nodes at which changes in capacitance are sensed; and a number of force regions comprising vertically-displaceable, sectioned portions of the capacitive touch sensor, the vertically-displaceable, sectioned portions including at least the sense electrode layer, the vertically-displaceable, sectioned portions of at least the sense electrode layer adapted to be flexed, compressed, or otherwise displaced towards the drive electrode layer responsive to touch surface depression.
Example 10: The apparatus according to Example 9, wherein: the capacitive touch sensor includes: a protective layer over the sense electrode layer; an insulating layer between the sense electrode layer and the drive electrode layer; and the vertically-displaceable, sectioned portions are of the protective layer, the sense electrode layer, and the insulating layer, the insulating layer of the vertically-displaceable, sectioned portions comprising a flexible, compressible, or air gap layer.
Example 11: The apparatus according to Examples 9 and 10, wherein: the capacitive touch-sensitive area of the capacitive touch sensor is a substantially rigid, non-vertically-displaceable area, and the vertically-displaceable, sectioned portions are adapted to be flexed, compressed, or otherwise displaced toward the drive electrode layer, relative to the capacitive touch-sensitive area, responsive to the touch surface depression; or the vertically-displaceable, sectioned portions comprise modifications in mechanical, structural, and/or compositional properties of at least the sense electrode layer and the protective layer within the vertically-displaceable, sectioned portions.
Example 12: The apparatus according to any of Examples 9 to 11, wherein: the capacitive touch sensor is to: provide capacitive node measurements for capacitive touch detection responsive to touch at a respective one of multiple touch points within a capacitive touch-sensitive area of the capacitive touch sensor, the respective one of the multiple touch points corresponding to one or more first capacitive nodes of the array; and provide capacitive node measurements for force detection responsive to touch surface depression at a respective one of the vertically-displaceable, sectioned portions of the capacitive touch sensor, the respective one of the vertically-displaceable, sectioned portions corresponding to one or more second capacitive nodes of the array.
Example 13: The apparatus according to any of Examples 9 to 12, wherein: the capacitive node measurements for the capacitive touch detection responsive to the touch indicate a reduction in capacitance at the one or more first capacitive nodes of the array; and the capacitive node measurements for the force detection responsive to the touch surface depression indicate an increase in capacitance at the one or more second capacitive nodes of the array.
Example 14: The apparatus according to any of Examples 9 to 13, wherein: respective ones of the vertically-displaceable, sectioned portions are sized to fit a fingertip and are provided with surface textures or haptics for tactile feedback.
Example 15: The apparatus according to any of Examples 9 to 14, comprising: a push button device including: a top surface portion; a bottom surface portion, the bottom surface portion to mount to a touchscreen including the capacitive touch sensor; and a pressure pad member, the pressure pad member to vertically extend from the bottom surface portion, responsive to a depression of the top surface portion, to cause touch surface depression at one of the vertically-displaceable, sectioned portions.
Example 16: The apparatus according to any of Examples 9 to 15, wherein the vertically-displaceable, sectioned portions are arranged in an annulus of the capacitive touch sensor, the apparatus comprising: a Knob-on-Display (KoD) device comprising a rotary knob including: a top surface portion; a bottom surface portion, the bottom surface portion to mount to a touchscreen including the capacitive touch sensor; and a pressure pad member, the pressure pad member adapted to rotate around the rotary knob, responsive to rotation of the rotary knob, to apply substantially constant touch surface depression at respective ones of the vertically-displaceable, sectioned portions arranged in the annulus for angular position detection of the rotary knob.
Example 17: The apparatus according to any of Examples 9 to 16, wherein capacitive touch sensor includes a vertically-displaceable, sectioned portion in a center of the annulus of the capacitive touch sensor, and the pressure pad member comprises a first pressure pad member, the apparatus comprising: the KoD device comprising the rotary knob including: a second pressure pad member, the second pressure pad member to extend from the bottom surface portion responsive to a depression of the top surface portion, to cause touch surface depression at the vertically-displaceable, sectioned portion in the center of the annulus for push button detection.
Example 18: A method comprising: at a touch controller, receiving capacitive node measurements of a capacitive touch sensor; detecting, at least partially based on the capacitive node measurements, a touch event responsive to a touch within a capacitive touch-sensitive area of the capacitive touch sensor; and detecting, at least partially based on the capacitive node measurements, a touch surface depression event responsive to a touch surface depression at a force region of the capacitive touch sensor.
Example 19: The method according to Example 18, wherein the force region of the capacitive touch sensor comprises a vertically-displaceable, sectioned portion of one or more vertically-stacked layers of the capacitive touch sensor, the vertically-displaceable, sectioned portion of the one or more vertically-stacked layers of the capacitive touch sensor comprising a vertically-displaceable, flexible, or compressible portion adapted to be flexed, compressed, or otherwise displaced responsive to the touch surface depression.
Example 20: The method according to Examples 18 and 19, wherein the capacitive touch sensor includes a drive electrode layer and a sense electrode layer, the drive electrode layer and the sense electrode layer arranged to provide an array of interacting electrodes comprising capacitive nodes at which changes in capacitance are sensed.
Example 21: The method according to any of Examples 18 to 20, wherein: detecting the touch event comprises the capacitive node measurements indicating a reduction in capacitance at one or more first capacitive nodes associated with the capacitive touch-sensitive area; and detecting the touch surface depression event comprises the capacitive node measurements indicating an increase in capacitance at one or more second capacitive nodes associated with the force region.
Example 22: The method according to any of Examples 18 to 21, wherein: detecting the touch event comprises, for one or more first capacitive nodes associated with the capacitive touch-sensitive area: receiving one or more first voltage levels associated with first capacitive node measurements from the one or more first capacitive nodes; and determining that the one or more first voltage levels are outside a first limit set by a first threshold value; detecting the touch surface depression event comprises, for one or more second capacitive nodes associated with the force region: receiving one or more second voltage levels associated with second capacitive node measurements from the one or more second capacitive nodes; and determining that the one or more second voltage levels are outside a second limit set by a second threshold value.
Example 23: A touch controller comprising: one or more processors; a number of transmit lines for coupling to drive electrodes of a drive electrode layer of a capacitive touch sensor; a number of receive lines for coupling to sense electrodes of a sense electrode layer of the capacitive touch sensor, the sense electrode layer and the drive electrode layer of the capacitive touch sensor arranged to provide an array of interacting electrodes comprising capacitive nodes; a drive circuitry coupled to the one or more processors and to the number of transmit lines, the drive circuitry to drive modulated signals to the drive electrodes via respective ones of the number of transmit lines; a sense circuitry coupled to the one or more processors and the number of receive lines, the sense circuitry to sense capacitive node measurements from the sense electrodes via the respective ones of the number of receive lines; and the one or more processors to: detect a touch event responsive to the capacitive node measurements indicating a reduction in capacitance at one or more first capacitive nodes associated with a capacitive touch-sensitive area of the capacitive touch sensor; and detect a touch surface depression event responsive to the capacitive node measurements indicating an increase in capacitance at one or more second capacitive nodes associated with a vertically-displaceable, sectioned portion of the capacitive touch sensor.
Example 24: The touch controller according to Example 23, wherein: the one or more processors are to detect the touch event by, for the one or more first capacitive nodes associated with the capacitive touch-sensitive area: receive one or more first voltage levels associated with first capacitive node measurements from the one or more first capacitive nodes; and determine that the one or more first voltage levels are outside a first limit set by a first threshold value, which indicates the decrease in the capacitance at the one or more first capacitive nodes; the one or more processors are to detect the touch surface depression event by, for the one or more second capacitive nodes associated with the vertically-displaceable, sectioned portion: receive one or more second voltage levels associated with second capacitive node measurements from the one or more second capacitive nodes; and determine that the one or more second voltage levels are outside a second limit set by a second threshold value, which indicates the increase in the capacitance at the one or more second capacitive nodes.
Example 25: The touch controller according to Examples 23 and 24, wherein the vertically-displaceable, sectioned portion is in one or more vertically-stacked layers of the capacitive touch sensor, the vertically-displaceable, sectioned portion adapted to be flexed, compressed, or otherwise displaced responsive to a touch surface depression.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a capacitive touch sensor to:
provide first capacitive node measurements for capacitive touch detection responsive to touch at a respective one of multiple touch points within a capacitive touch-sensitive area of the capacitive touch sensor, the first capacitive node measurements indicating a reduction in capacitance at one or more first capacitive nodes of the capacitive touch sensor; and
provide second capacitive node measurements for force detection responsive to touch surface depression at a respective one of one or more force regions of the capacitive touch sensor, the second capacitive node measurements indicating an increase in capacitance at one or more second capacitive nodes of the capacitive touch sensor.

2. The apparatus of claim 1, wherein:
the capacitive touch sensor comprises a number of vertically-stacked layers; and
respective ones of the one or more force regions comprise vertically-displaceable, sectioned portions of one or more vertically-stacked layers of the capacitive touch sensor.

3. The apparatus of claim 2, wherein:
the respective ones of the one or more force regions comprising the vertically-displaceable, sectioned portions comprise vertically-displaceable, flexible, or compressible portions adapted to be flexed, compressed, or otherwise displaced responsive to the touch surface depression.

4. The apparatus of claim 2, wherein:
the one or more vertically-stacked layers of the vertically-displaceable, sectioned portions include at least an electrode layer of the capacitive touch sensor.

5. The apparatus of claim 2, wherein:
the number of vertically-stacked layers of the capacitive touch sensor include:
a drive electrode layer including drive electrodes;
a sense electrode layer including sense electrodes, the drive electrode layer and the sense electrode layer arranged to provide an array of interacting electrodes comprising capacitive nodes at which changes in capacitance are sensed; and
the one or more vertically-stacked layers of the vertically-displaceable, sectioned portions include at least the sense electrode layer.

6. The apparatus of claim 5, wherein:
the capacitive touch-sensitive area of the capacitive touch sensor is a substantially rigid, non-perpendicularly-displaceable area; and
respective ones of the vertically-displaceable, sectioned portions of the one or more vertically-stacked layers of the capacitive touch sensor are mechanically isolated or separated from the capacitive touch-sensitive area and adapted to be flexed, compressed, or otherwise displaced toward the drive electrode layer, relative to the capacitive touch-sensitive area, responsive to touch surface depression.

7. The apparatus of claim 6, wherein:
the number of vertically-stacked layers of the capacitive touch sensor include an insulating layer between the drive electrode layer and the sense electrode layer; and
the one or more vertically-stacked layers of the vertically-displaceable, sectioned portions include at least the sense electrode layer and the insulating layer, the insulating layer of the vertically-displaceable, sectioned portions comprising a flexible, compressible, or air gap layer.

8. The apparatus of claim 1, comprising:
a touch controller to:
receive the first capacitive node measurements;
detect, at least partially based on the first capacitive node measurements indicating the reduction in capacitance, a touch event responsive to the touch at the respective one of the multiple touch points within the capacitive touch-sensitive area;
receive the second capacitive node measurements; and
detect, at least partially based on the second capacitive node measurements indicating the increase in capacitance, a touch surface depression event responsive to the touch surface depression at the respective one of the one or more force regions.

9. An apparatus comprising:
a capacitive touch sensor comprising a number of vertically-stacked layers including:
a drive electrode layer including drive electrodes;
a sense electrode layer including sense electrodes, the drive electrode layer and the sense electrode layer arranged to provide an array of interacting electrodes comprising capacitive nodes at which changes in capacitance are sensed; and
a number of force regions comprising vertically-displaceable, sectioned portions of the capacitive touch sensor, the vertically-displaceable, sectioned portions including at least the sense electrode layer, the vertically-displaceable, sectioned portions including at least the sense electrode layer adapted to be flexed, compressed, or otherwise displaced towards the drive electrode layer responsive to touch surface depression.

10. The apparatus of claim 9, wherein:
the capacitive touch sensor includes:
a protective layer over the sense electrode layer;
an insulating layer between the sense electrode layer and the drive electrode layer; and
the vertically-displaceable, sectioned portions are of the protective layer, the sense electrode layer, and the insulating layer, the insulating layer of the vertically-displaceable, sectioned portions comprising a flexible, compressible, or air gap layer.

11. The apparatus of claim 9, wherein:
a capacitive touch-sensitive area of the capacitive touch sensor is a substantially rigid, non-vertically-displaceable area, and the vertically-displaceable, sectioned portions are mechanically isolated or separated from the capacitive touch-sensitive area and adapted to be flexed, compressed, or otherwise displaced toward the drive electrode layer, relative to the capacitive touch-sensitive area, responsive to the touch surface depression; or
the vertically-displaceable, sectioned portions comprise modifications in mechanical, structural, and/or compositional properties of at least the sense electrode layer and a protective layer within the vertically-displaceable, sectioned portions.

12. The apparatus of claim 9, wherein:
the capacitive touch sensor is to:
provide capacitive node measurements for capacitive touch detection responsive to touch at a respective one of multiple touch points within a capacitive touch-sensitive area of the capacitive touch sensor, the respective one of the multiple touch points corresponding to one or more first capacitive nodes of the array; and
provide capacitive node measurements for force detection responsive to touch surface depression at a respective one of the vertically-displaceable, sectioned portions of the capacitive touch sensor, the respective one of the vertically-displaceable, sectioned portions corresponding to one or more second capacitive nodes of the array.

13. The apparatus of claim 12, wherein:
the capacitive node measurements for the capacitive touch detection responsive to the touch indicate a reduction in capacitance at the one or more first capacitive nodes of the array; and
the capacitive node measurements for the force detection responsive to the touch surface depression indicate an increase in capacitance at the one or more second capacitive nodes of the array.

14. The apparatus of claim 9, wherein:
respective ones of the vertically-displaceable, sectioned portions are sized to fit a fingertip and are provided with surface textures or haptics for tactile feedback.

15. The apparatus of claim 9, comprising:
a push button device including:
a top surface portion;
a bottom surface portion, the bottom surface portion to mount to a touchscreen including the capacitive touch sensor; and
a pressure pad member, the pressure pad member to vertically extend from the bottom surface portion, responsive to a depression of the top surface portion, to cause touch surface depression at one of the vertically-displaceable, sectioned portions.

16. The apparatus of claim 9, wherein the vertically-displaceable, sectioned portions are arranged in an annulus of the capacitive touch sensor, the apparatus comprising:
a Knob-on-Display (KoD) device comprising a rotary knob including:
a top surface portion;
a bottom surface portion, the bottom surface portion to mount to a touchscreen including the capacitive touch sensor; and
a pressure pad member, the pressure pad member adapted to rotate around the rotary knob, responsive to rotation of the rotary knob, to apply substantially constant touch surface depression at respective ones of the vertically-displaceable, sectioned portions arranged in the annulus for angular position detection of the rotary knob.

17. The apparatus of claim 16, wherein capacitive touch sensor includes a vertically-displaceable, sectioned portion in a center of the annulus of the capacitive touch sensor, and the pressure pad member comprises a first pressure pad member, the apparatus comprising:
the KoD device comprising the rotary knob including:
a second pressure pad member, the second pressure pad member to extend from the bottom surface portion responsive to a depression of the top surface portion, to cause touch surface depression at the vertically-displaceable, sectioned portion in the center of the annulus for push button detection.

18. A method comprising:
at a touch controller,
receiving capacitive node measurements of a capacitive touch sensor;
detecting, at least partially based on the capacitive node measurements, a touch event responsive to a touch within a capacitive touch-sensitive area of the capacitive touch sensor; and
detecting, at least partially based on the capacitive node measurements, a touch surface depression event responsive to a touch surface depression at a force region of the capacitive touch sensor.

19. The method of claim 18, wherein the force region of the capacitive touch sensor comprises a vertically-displaceable, sectioned portion of one or more vertically-stacked layers of the capacitive touch sensor, the vertically-displaceable, sectioned portion of the one or more vertically-stacked layers of the capacitive touch sensor comprising a vertically-displaceable, flexible, or compressible portion adapted to be flexed, compressed, or otherwise displaced responsive to the touch surface depression.

20. The method of claim 18, wherein the capacitive touch sensor includes a drive electrode layer and a sense electrode layer, the drive electrode layer and the sense electrode layer arranged to provide an array of interacting electrodes comprising capacitive nodes at which changes in capacitance are sensed.

21. The method of claim 18, wherein:
detecting the touch event comprises the capacitive node measurements indicating a reduction in capacitance at one or more first capacitive nodes associated with the capacitive touch-sensitive area; and
detecting the touch surface depression event comprises the capacitive node measurements indicating an increase in capacitance at one or more second capacitive nodes associated with the force region.

22. The method of claim 18, wherein:
detecting the touch event comprises, for one or more first capacitive nodes associated with the capacitive touch-sensitive area:
receiving one or more first voltage levels associated with first capacitive node measurements from the one or more first capacitive nodes; and
determining that the one or more first voltage levels are outside a first limit set by a first threshold value;
detecting the touch surface depression event comprises, for one or more second capacitive nodes associated with the force region:
receiving one or more second voltage levels associated with second capacitive node measurements from the one or more second capacitive nodes; and
determining that the one or more second voltage levels are outside a second limit set by a second threshold value.

23. A touch controller comprising:
one or more processors;
a number of transmit lines for coupling to drive electrodes of a drive electrode layer of a capacitive touch sensor;
a number of receive lines for coupling to sense electrodes of a sense electrode layer of the capacitive touch sensor, the sense electrode layer and the drive electrode layer of the capacitive touch sensor arranged to provide an array of interacting electrodes comprising capacitive nodes;
a drive circuitry coupled to the one or more processors and to the number of transmit lines, the drive circuitry to drive modulated signals to the drive electrodes via respective ones of the number of transmit lines;
a sense circuitry coupled to the one or more processors and the number of receive lines, the sense circuitry to sense capacitive node measurements from the sense electrodes via the respective ones of the number of receive lines; and
the one or more processors to:
detect a touch event responsive to the capacitive node measurements indicating a reduction in capacitance at one or more first capacitive nodes associated with a capacitive touch-sensitive area of the capacitive touch sensor; and
detect a touch surface depression event responsive to the capacitive node measurements indicating an increase in capacitance at one or more second capacitive nodes associated with a vertically-displaceable, sectioned portion of the capacitive touch sensor.

24. The touch controller of claim 23, wherein:
the one or more processors are to detect the touch event by, for the one or more first capacitive nodes associated with the capacitive touch-sensitive area:
receive one or more first voltage levels associated with first capacitive node measurements from the one or more first capacitive nodes; and
determine that the one or more first voltage levels are outside a first limit set by a first threshold value, which indicates the decrease in the capacitance at the one or more first capacitive nodes;
the one or more processors are to detect the touch surface depression event by, for the one or more second capacitive nodes associated with the vertically-displaceable, sectioned portion:
receive one or more second voltage levels associated with second capacitive node measurements from the one or more second capacitive nodes; and
determine that the one or more second voltage levels are outside a second limit set by a second threshold value, which indicates the increase in the capacitance at the one or more second capacitive nodes.

25. The touch controller of claim 23, wherein the vertically-displaceable, sectioned portion is in one or more vertically-stacked layers of the capacitive touch sensor, the vertically-displaceable, sectioned portion adapted to be flexed, compressed, or otherwise displaced responsive to a touch surface depression.
